(19) United States
(12) Patent Application Publication
(10) Pub. No.: US 2023/0371565 A1
(43) Pub. Date: Nov. 23, 2023

(54) CRUDE TAHINI WITH EXTENDED SHELF LIFE, METHODS OF PREPARING SAME AND RELATED PRODUCTS AND METHODS

(71) Applicant: Gil NOFAR, Haifa (IL)

(72) Inventor: Gil NOFAR, Haifa (IL)

(21) Appl. No.: 18/260,603

(22) PCT Filed: Jan. 6, 2022
(86) PCT No.: PCT/IL2022/050022

§ 371 Date: Jul. 6, 2023

Related U.S. Application Data
(60) Provisional application No. 63/221,499, filed on Jul. 14, 2021.
(60) Provisional application No. 63/134,592, filed on Jan. 7, 2021.

(51) Int. Cl. A23L 25/00; A23L 3/46; A23L 35/00

(52) U.S. Cl. CPC A23L 25/30; A23L 3/46; A23L 35/10

(57) ABSTRACT

A method including mixing a paste of oily seeds and water to produce a pre-mix; and microfluidizing at least the paste or premix at a pressure of at least 5,000 PSI. Examples of oily seeds include but are not limited to sesame seeds and olives. Products produced by the method constitute additional embodiments of the invention.

### DETAILS OF RELATED APPLICATIONS

This PCT application claims priority according to 35 U.S.C. §119(e) from US provisional application 63/134,592 filed on Jan. 7, 2021, and from US provisional application 63/221,499 filed on Jul. 14, 2021 and each of these earlier applications is fully incorporated herein by reference.

### FIELD OF THE INVENTION

The invention is in the field of food technology.

### BACKGROUND OF THE INVENTION

Sesame seeds are valued for their emulsifying qualities. Alternatively or additionally, sesame seeds are valued for their amino acid profile, calcium content, iron content, and vitamins which contribute to a health benefit.

As a result of these emulsifying qualities and/or health benefits, ground sesame seeds and/or sesame oil seeds are a common ingredient in cuisines of the middle east and far east.

Ground hulled sesame seeds are typically processed into a paste known as tahini.

Tahini paste, which will be referred to hereinbelow as crude tahini, is often mixed with water to prepare a dip or spread which is also called tahini. In order to avoid confusion, this application will refer to the product prepared by mixing water with crude tahini as prepared tahini. In many cases, prepared tahini includes additional ingredients such as lemon juice, salt, pepper, and other seasonings and/or antioxidants and/or anticaking agents.

Crude tahini contains essential nutrients, such as calcium, copper, manganese, protein, omega-3, omega-6, and fibers, yet low in levels of sugar and saturated fats

Crude tahini is typically made by first separating the hulls from the seeds.

(In some cases the hulls are left on the seeds, or added back to the hulled seeds, and the resultant paste is referred to as whole crude tahini.) The seeds are then, roasted, and ground to produce crude tahini. (In some cases, roasting is omitted and the resultant crude tahini is referred to as raw crude tahini).

Because tahini paste has a high oil content, oiling off occurs during storage. When oiling off occurs, the paste separates into an oil phase and a solid sediment. Recombining the oil phase and sediment after oiling off occurs is difficult.

### SUMMARY OF THE INVENTION

One aspect of some embodiments of the invention relates to microfluidization of oily seeds. In some embodiments, microfluidization produces a paste with a low viscosity (compared to a similar paste made by conventional grinding). In some embodiments, microfluidization is conducted after conventional grinding. In some exemplary embodiments of the invention, a leftward shift in a PSD plot (compared to a similar paste made by conventional grinding) contributes to the reduction in viscosity. In other exemplary embodiments of the invention, the reduction in viscosity is independent of a change in PSD. According to various exemplary embodiments of the invention microfluidization of oily seeds produces products specific to the type of oily seed employed. For example, one category of products is crude tahini. In some embodiments, microfluidized tahini has lower viscosity than tahini with a similar PSD. Another category of product is liquefied olives.

Another aspect of some embodiments of the invention relates to a method to produce tahini paste with an unusual particle size distribution (PSD). According to various exemplary embodiments of the invention the size below which 50%; 90%; 95%; 99% or 100% % of particles fall is adjusted downwards. In some embodiments, microfluidization contributes to a decrease in particle size. In some embodiments, a shift in PSD slows down the oiling off process during storage and/or contributes to a reduction in viscosity. For purposes of this specification and the accompanying claims, the term “shelf life” indicates an amount of time before 12% of total volume of the crude tahini is separated oil at room temperature.

An additional aspect of some embodiments of the invention relates to preparing tahini by soaking the sesame seeds for an extended period of time before removing the hulls. According to various exemplary embodiments of the invention, the seeds are soaked for 1, 2, 4, 6, 8, 10, 12, 24, 16, 18, 20, 22, 24 or intermediate or greater number of hours. In some exemplary embodiments of the invention, soaking contributes to sprouting and/or production of GABA. In some embodiments, hulls are removed and then the peeled seeds are soaked.

A further additional aspect of some embodiments of the invention relates to drying crude tahini and/or prepared tahini to produce a powdered tahini product. In some embodiments, the powdered tahini product contains rice bran extract (RBE) or another emulsifier. According to various exemplary embodiments of the invention, the drying is in a spray dryer or drum dryer or vacuum spray dryer. According to various exemplary embodiments of the invention which employ RBE the amount of RBE <12%, <11%, <10%, <9%, <8%, <7%, <6%, <5%, <4%, <3%, <2%, <1%, <0.1% or intermediate or lower percentages relative to the weight of crude tahini. Alternatively or additionally, according to various exemplary embodiments of the invention which employ RBE the amount of RBE >12%, >11%, >10%, >9%, >8%, >7%, >6%, >5%, >4%, >3%, >2%, >1%, >0.1% or intermediate or higher percentages relative to the weight of crude tahini.

Yet another aspect of some embodiments of the invention relates to the microfluidization of an emulsion prepared from crude tahini or a paste made from any nut or oily seed. In some embodiments, rice bran extract contributes to a reduction in separation of the emulsion and/or to a shift in particle size distribution. Alternatively or additionally, in some embodiments the emulsion is dried to form a powder.

Still another aspect of some embodiments of the invention relates to a powderized paste prepared from any nut or oily seed via drying. In some embodiments the drying is spray drying. In some embodiments, addition of water to the paste makes it more amenable to spray drying. In some exemplary embodiments of the invention, the nut or oily seed is microfluidized prior to drying. According to various exemplary embodiments of the invention a PSD of the microfluidized product is determined by laser diffraction using water or ISOPAR G as a dispersant.

According to various exemplary embodiments, various aspects which are described individually for clarity are combined in pairs, triplets, quadruplets or combinations of greater numbers.

It will be appreciated that the various aspects described above relate to solution of technical problems associated with oiling off.

Alternatively or additionally, it will be appreciated that the various aspects described above relate to solution of technical problems associated with undesirable rheology characteristics of tahini among many consumers.

Alternatively or additionally, it will be appreciated that the various aspects described above relate to solution of technical problems related to bacterial contamination in crude tahini.

For purposes of this specification and the accompanying claims, the term “any crude tahini” indicates crude tahini, whole crude tahini, tahini with hulls added and any combination thereof.

In some exemplary embodiments of the invention there is provided a crude tahini composition characterized by a Particle Size Distribution (PSD) of 90% of less than 46 μm as measured by laser diffraction using a Malvern—Mastersizer 3000 Wet dispersion with Hydro EV cell with water as dispersant. In some embodiments the crude tahini composition is characterized by a Particle Size Distribution (PSD) of 90% of less than 55 μm as measured using a Malvern—Mastersizer 3000 Wet dispersion with Hydro EV cell with Isopar G as dispersant by laser diffraction. Alternatively or additionally, in some embodiments the crude tahini composition is characterized by a Particle Size Distribution (PSD) of 95% of less than 90 μm as measured by laser diffraction using water as a dispersant. Alternatively or additionally, in some embodiments the crude tahini composition is characterized by a Particle Size Distribution (PSD) of 95% of 80 μm or less as measured by laser diffraction using Isopar G as a dispersant. Alternatively or additionally, in some embodiments the crude tahini composition is characterized by a Particle Size Distribution (PSD) of 99% of less than 179 μm as measured by laser diffraction using water as a dispersant. Alternatively or additionally, in some embodiments the crude tahini composition is characterized by a Particle Size Distribution (PSD) of 99% of 180 μm or less as measured by laser diffraction using Isopar G as a dispersant. Alternatively or additionally, in some embodiments the crude tahini composition is characterized by a Particle Size Distribution (PSD) of 100% of less than 272 μm as measured by laser diffraction using water as a dispersant. Alternatively or additionally, in some embodiments the crude tahini composition is characterized by a Particle Size Distribution (PSD) of 100% of 98 μm or less as measured by laser diffraction using Isopar G as a dispersant. Alternatively or additionally, in some embodiments the crude tahini composition is characterized by a viscosity cP SC4-21 at 5 RPM of 2110 or less. Alternatively or additionally, in some embodiments the crude tahini composition is characterized by a viscosity cP SC4-21 at 11 RPM of less than 1770.

In some exemplary embodiments of the invention there is provided a whole grain (with hulls) crude tahini composition characterized by a Particle Size Distribution (PSD) of 90% of less than 46 μm as measured by laser diffraction using a Malvern—Mastersizer 3000 Wet dispersion with Hydro EV cell with water as dispersant.

In some embodiments the whole grain crude tahini composition is characterized by a Particle Size Distribution (PSD) of 90% of 40 μm or less as measured by laser diffraction using water as a dispersant. Alternatively or additionally, in some embodiments the whole grain crude tahini composition is characterized by a Particle Size Distribution (PSD) of 95% of less than 117 μm as measured by laser diffraction using water as a dispersant. Alternatively or additionally, in some embodiments the whole grain crude tahini composition is characterized by a Particle Size Distribution (PSD) of 95% of 90 μm or less as measured by laser diffraction using water as a dispersant. Alternatively or additionally, in some embodiments the whole grain crude tahini composition is characterized by a Particle Size Distribution (PSD) of 99% of less than 181 urn as measured by laser diffraction using water as a dispersant. Alternatively or additionally, in some embodiments the whole grain crude tahini composition is characterized by a Particle Size Distribution (PSD) of 99% of 150 μm or less as measured by laser diffraction using water as dispersant. Alternatively or additionally, in some embodiments the whole grain crude tahini composition is characterized by a Particle Size Distribution (PSD) of 100% of 270 μm or less as measured by laser diffraction using water as a dispersant. Alternatively or additionally, in some embodiments the whole grain crude tahini composition is characterized by a Particle Size Distribution (PSD) of 100% of 185 μm or less as measured by laser diffraction using water as a dispersant. Alternatively or additionally, in some embodiments the whole grain crude tahini composition is characterized by a viscosity cP SC4-21 at 11 RPM of 1400 or less.

In some exemplary embodiments of the invention there is provided a crude tahini composition characterized by a Particle Size Distribution (PSD) of 90% of less than 55 μm as measured by laser diffraction using a Malvern—Mastersizer 3000 Wet dispersion with Hydro EV cell with Isopar G as dispersant. In some embodiments the crude tahini composition is characterized by a Particle Size Distribution (PSD) of 90% of 40 μm or less as measured by laser diffraction using Isopar G as a dispersant. Alternatively or additionally, in some embodiments the crude tahini composition is characterized by a Particle Size Distribution (PSD) of 95% of less than 80 μm as measured by laser diffraction using Isopar G as a dispersant. Alternatively or additionally, in some embodiments the crude tahini composition is characterized by a Particle Size Distribution (PSD) of 95% of 70 μm or less as measured by laser diffraction using Isopar G as a dispersant. Alternatively or additionally, in some embodiments the crude tahini composition is characterized by a Particle Size Distribution (PSD) of 99% of less than 117 μm as measured by laser diffraction using Isopar G as a dispersant. Alternatively or additionally, in some embodiments the crude tahini composition is characterized by a Particle Size Distribution (PSD) of 99% of 90 μm or less as measured by laser diffraction using Isopar G as a dispersant. Alternatively or additionally, in some embodiments the crude tahini composition is characterized by a Particle Size Distribution (PSD) of 100% of less than 160 μm as measured by laser diffraction using Isopar G as a dispersant. Alternatively or additionally, in some embodiments the crude tahini composition is characterized by a Particle Size Distribution (PSD) of 100% of 120 μm μm or less as measured by laser diffraction using Isopar G as a dispersant. Alternatively or additionally, in some embodiments the crude tahini composition is characterized by a viscosity cP SC4-21 at 5 RPM of less than 2100. Alternatively or additionally, in some embodiments the crude tahini composition is characterized by a viscosity cP SC4-21 at 11 RPM of less than 1770.

In some exemplary embodiments of the invention there is provided a whole grain (with hulls) crude tahini composition characterized by a Particle Size Distribution (PSD) of 90% of less than 72 μm as measured by laser diffraction using a Malvern—Mastersizer 3000 Wet dispersion with Hydro EV cell with ISOPAR G as dispersant. In some embodiments the whole grain crude tahini composition is characterized by a Particle Size Distribution (PSD) of 90% of 55 μm or less as measured by laser diffraction using ISOPAR G as dispersant. Alternatively or additionally, in some embodiments the whole grain crude tahini composition is characterized by a Particle Size Distribution (PSD) of 95% of less than 101 μm as measured by laser diffraction using ISOPAR G as dispersant. Alternatively or additionally, in some embodiments the whole grain crude tahini composition is characterized by a Particle Size Distribution (PSD) of 95% of 80 μm or less as measured by laser diffraction using ISOPAR G as dispersant. Alternatively or additionally, in some embodiments the whole grain crude tahini composition is characterized by a Particle Size Distribution (PSD) of 99% of less than 143 μm as measured by laser diffraction using ISOPAR G as dispersant. Alternatively or additionally, in some embodiments the whole grain crude tahini composition is characterized by a Particle Size Distribution (PSD) of 99% of 120 μm or less as measured by laser diffraction using ISOPAR G as dispersant. Alternatively or additionally, in some embodiments the whole grain crude tahini composition is characterized by a Particle Size Distribution (PSD) of 100% of less than 184 μm as measured by laser diffraction using ISOPAR G as dispersant. Alternatively or additionally, in some embodiments the whole grain crude tahini composition is characterized by a Particle Size Distribution (PSD) of 100% of 165 μm or less as measured by laser diffraction using ISOPAR G as dispersant. Alternatively or additionally, in some embodiments the whole grain crude tahini composition is characterized by a viscosity cP SC4-21 at 11 RPM of less than 1417.

In some exemplary embodiments of the invention there is provided a method including microfluidizing crude tahini at a pressure of at least 5,000 PSI. In some embodiments the crude tahini includes whole crude tahini (with hulls). Alternatively or additionally, in some embodiments the method includes preparing the crude tahini from sesame seeds. Alternatively or additionally, in some embodiments the preparing crude tahini includes grinding in a ball mill. Alternatively or additionally, in some embodiments the preparing crude tahini includes grinding with millstones or Macintyre (as used in the chocolate industry) or a Reifiner Conche. According to various exemplary embodiments of the invention the crude tahini is ground sufficiently fine so that it can be processed by microfluidizing machinery.

In some exemplary embodiments of the invention there is provided method of producing crude tahini including soaking sesame seeds in water for a minimum of 1 hours; and grinding to produce tahini paste. In some embodiments the method includes removing hulls from the sesame seeds. Alternatively or additionally, in some embodiments, sesame hulls are added prior to grinding.

Alternatively or additionally, in some embodiments the method includes roasting the sesame seeds. Alternatively or additionally, in some embodiments the method includes microfluidizing the tahini paste. Alternatively or additionally, in some embodiments grinding must produce particle sizes in conformity with an entrance of the first microfluidization tube.

In some exemplary embodiments of the invention there is provided a method including: (a) mixing crude tahini and water to produce an emulsion; and (b) microfluidizing said crude tahini or said emulsion at a pressure of at least 5,000 PSI. In some embodiments, the method includes: (c) spray drying the emulsion to produce powderized tahini. In some exemplary embodiments of the invention there is provided a method including: (a) mixing crude tahini and water to produce an emulsion; and (b) spray drying the emulsion to produce powderized tahini. In some embodiments of these methods, the method includes dissolving rice bran extract <12% of the weight of the crude tahini in the water. Alternatively or additionally, in some embodiments of these methods the spray drying employs a Niro dryer with a height of 3M and an entrance temperature of 200° C. to 210° C. Alternatively or additionally, in some embodiments of these methods the spray drying employs a Niro dryer with a height of 3M and an exit temperature of 110° C. or less. Alternatively or additionally, in some embodiments the spray drying employs a vacuum spray dryer and/or drum dryer.

The method covers four separate possibilities.

The first possibility is microfluidization of crude tahini followed by mixing with water to form an initial emulsion which is then microfluidized again and then dried to produce powderized tahini.

The second possibility is mixing crude tahini with water to produce emulsion followed by microfluidization and drying to produce powderized tahini.

The third possibility is microlfluidizing crude tahini and (in parallel or before) mixing water with rice bran extract <12% of the weight of crude tahini. In some embodiments, another emulsifier is used instead of or together with RBE. In some embodiments, this mixture of water and RBE is heated, optionally boiled, and then cooled. The microfluidized tahini is then mixed with the water/RBE solution to produce an emulsion. In some embodiments, the emulsion is microfluidized then dried. In other exemplary embodiments of the invention, emulsion is dried directly. In either case, the result is powderized tahini.

The fourth possibility is mixing rice bran extract (RBE) <12% of the weight of crude tahini with water. In some embodiments, another emulsifier is used instead of or together with RBE. In some embodiments, this mixture of water and RBE is heated, optionally boiled, and then cooled. Crude tahini is then added to the water/RBE mixture to produce an emulsion which is either dried directly, or microfluidized and then dried. In either case, the result is powderized tahini.

In some exemplary embodiments of the invention there is provided a powder composition including a spray-dried microfluidized emulsion comprising crude tahini and water. In some exemplary embodiments of the invention there is provided a powder composition including a spray-dried emulsion comprising crude tahini and water. In some embodiments these compositions include rice bran extract. In other exemplary embodiments of the invention, other emulsifiers such as lecithin or monoglycerides or diglycerides or TWEEN or saponin or polysorbate are used instead of RBE.

Alternatively or additionally, in some embodiments these compositions include seasonings and/or antioxidants and/or anticaking agents.

In some exemplary embodiments of the invention there is provided method including:(a) grinding seeds to produce a paste; (b) mixing the paste and water to produce a pre-mix; (c) microfluidizing the paste and/or emulsion at a pressure of at least 5,000 PSI; and (d) spray drying to produce a powderized oily seed composition. In some exemplary embodiments of the invention, both the paste and the emulsion are microfluidized.

In some exemplary embodiments of the invention there is provided a method including: (a) grinding oily seeds to produce a paste; (b) mixing the paste and water to produce a pre-mix; and (c) spray drying the pre-mix to produce a powderized oily seed composition. In some embodiments these methods include dissolving rice bran extract <12% of the weight of the oily seeds in the water. In other exemplary embodiments of the invention, other emulsifiers such as lecithin or monoglycerides or diglycerides or TWEEN or saponin or polysorbate are used instead of RBE.

According to various exemplary embodiments of the invention other emulsifiers are used in place of or together with RBE.

In some exemplary embodiments of the invention there is provided a powder composition including a spray-dried microfluidized homogenate, said homogenate including oily seeds and water. In some exemplary embodiments of the invention there is provided a powder composition including a spray-dried homogenate, wherein said homogenate comprises oily seeds and water. In some embodiments these compositions include rice bran extract. In other exemplary embodiments of the invention, other emulsifiers such as monoglycerides or diglycerides or TWEEN or saponin or polysorbate are used instead of RBE. Alternatively or additionally, in some embodiments these compositions include seasonings and/or antioxidants and/or anticaking agents.

The method covers four separate possibilities.

The first possibility is microfluidization of paste followed by mixing with water to form a premix which is then microfluidized and then dried to produce powderized oily seeds. The second possibility is mixing paste with water to produce premix followed by microfluidization and drying.

The third possibility is microfluidizing paste and (in parallel or before) mixing water with rice bran extract <12% of the weight of paste. In some embodiments, another emulsifier is used instead of or together with RBE. In some embodiments, this mixture of water and RBE is heated, optionally boiled, and then cooled. The microfluidized paste is then mixed with the water/RBE solution to produce premix. In some embodiments, the premix is microfluidized then dried. In other exemplary embodiments of the invention, premix is dried directly. In either case, the result is powderized oily seeds.

The fourth possibility is mixing rice bran extract (RBE) <12% of the weight of paste with water. In some embodiments, another emulsifier is used instead of RBE. In some embodiments, this mixture of water and RBE is heated, optionally boiled, and then cooled. Paste is then added to the water/RBE mixture to produce premix which is either dried directly, or microfluidized and then dried. In either case, the result is powderized oily seeds. In other exemplary embodiments of the invention, other emulsifiers such as lecithin or monoglycerides or diglycerides or TWEEN or saponin or polysorbate are used instead of or together with RBE.

In some exemplary embodiments of the invention there is provided a crude tahini composition with a viscosity cP SC4-21 at 5 RPM of 2050 or less or 2000 or less. In some embodiments viscosity cP SC4-21 at 5 RPM is 1700 or less or 1500 or less. Alternatively or additionally, in some embodiments the viscosity cP SC4-21 at 11 RPM is less than 1796, less than 1750, less than 1633, less than 1400, less than 1000 or intermediate or lower values.

In some exemplary embodiments of the invention there is provided a whole grain crude tahini composition having a viscosity cP SC4-21 at 11 RPM of 1795, 1633 or less, 1400 or less, 1300 or less or intermediate or lower values.

In some exemplary embodiments of the invention there is provided a method including: (a) mixing a paste of oily seeds and water to produce a pre-mix; and (b) microfluidizing said paste and/or said premix at a pressure of at least 5,000 PSI.

In some embodiments, the method includes grinding the oily seeds to produce a paste. Alternatively or additionally, in some embodiments the method includes spray drying to produce a powderized oily seed composition. Alternatively or additionally, in some embodiments the oily seeds include sesame seeds.

In some exemplary embodiments of the invention there is provided a method including: (a) treating pitted fresh olives with an alkaline reagent; (b) rinsing the olives with water to reduce the pH; and (c) grinding the olive prior microfluidizing the olives to produce a paste. In some embodiments the method includes drying or removing water and/or, the method includes adding oil to the paste. Alternatively or additionally, in some embodiments the method includes grinding the olives. Alternatively or additionally, in some embodiments the method includes grinding the olive (dried) and adding oil prior to microfluidizing. Microfludizing to a paste.

In some exemplary embodiments of the invention there is provided a method including: (a) removing seed fragments from olive pomace to produce smooth pomace; (b) heating the smooth pomace to produce dried smooth pomace; and (c) grinding the olive and adding oil prior to microfluidizing the dried smooth pomace. In some embodiments, the method includes adding oil to the microfluidized dried smooth pomace. Alternatively or additionally, in some embodiments the method includes grinding the smooth pomace or the dried smooth pomace prior to microfluidizing. Alternatively or additionally, in some embodiments the method includes grinding the smooth pomace to microfluidizing and drying or removing water and adding oil to the paste.

In some exemplary embodiments of the invention there is provided a processed olive composition characterized by a Particle Size Distribution (PSD) of 90% of less than 50 μm as measured by laser diffraction using a Malvern—Mastersizer 3000 Wet dispersion with Hydro EV cell with Isopar G as dispersant.

In some exemplary embodiments of the invention there is provided a processed olive composition characterized by a Particle Size Distribution (PSD) of 50% of less than 20 μm as measured by laser diffraction using a Malvern—Mastersizer 3000 Wet dispersion with Hydro EV cell with Isopar G as dispersant. In some embodiments, the processed olive composition(s) as described above is characterized by a viscosity cP SC4-21 at 5 RPM of 750 or less. Alternatively or additionally, in some embodiments the processed olive composition(s) as described above is characterized by a viscosity cP SC4-21 at 11 RPM of 850 or less.

In some exemplary embodiments of the invention there is provided a whole grain crude tahini composition having at least 13% crude fiber in a proximate analysis and characterized by a Particle Size Distribution (PSD) of 90% of less than 115 μm as measured by laser diffraction using a Malvern—Mastersizer 3000 Wet dispersion with Hydro EV cell with ISOPAR G as dispersant. In some embodiments, the whole grain crude tahini composition is characterized by a Particle Size Distribution (PSD) of 50% of less than 8.9 μm as measured by laser diffraction. Alternatively or additionally, in some embodiments the whole grain crude tahini composition is characterized by a viscosity cP SC4-21 at 11 RPM of less than 4000 and/or by a viscosity cP SC4-21 at 5 RPM of less than 4900.

In some exemplary embodiments of the invention there is provided a crude tahini composition which is perceived in organoleptic testing as not sticky or not grabbing the mouth even after mixing with saliva.

In some exemplary embodiments of the invention there is provided a method including:

(a) microfluidizing crude tahini to produce microfluidized crude tahini; and (b) removing oil from the microfluidized crude tahini. In some embodiments, removing oil includes centrifuging the microfluidized crude tahini. Alternatively or additionally, in some embodiments the removing oil removes at least 10% of the oil.

In some exemplary embodiments of the invention there is provided a reduced fat microfluidized crude tahini composition having a viscosity cP SC4-21 at 11 RPM of 2268 or less. Alternatively or additionally, in some exemplary embodiments of the invention there is provided a reduced fat microfluidized crude tahini composition having a viscosity cP SC4-21 at 5 RPM of 2800 or less. According to various exemplary embodiments of the invention, the reduced fat tahini composition has 10%, 15%, 20%, 25% or 30% or intermediate or higher percentages less fat that standard tahini from which it is prepared. In some embodiments, the reduced fat microfluidized crude tahini composition has a higher PSD as the full fat material from which it is prepared but higher viscosity.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) and/or ratios of crude tahini and water are expressed in terms of weight unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements, or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1A is a simplified flow diagram of an analysis scheme according to some exemplary embodiments of the invention;

FIG. 1B is a plot of volume density % as a function of size in μm for “Har Bracha” crude tahini analyzed by laser diffraction (details of assay conditions are provided herein below) using Isopar G as a dispersant;

FIG. 1C is a plot of volume density % as a function of size in μm for crude tahini Har Bracha 0 after microfluidization according to an exemplary embodiment of the invention as in FIG. 1B analyzed by laser diffraction using ISOPAR G as a dispersant;

FIG. 2A is a plot of volume density % as a function of size in μm for “Nesher” whole crude tahini analyzed by laser diffraction (details of assay conditions are provided hereinbelow) using Isopar G as a dispersant;

FIG. 2B is a plot of volume density % as a function of size in μm for “Nesher” whole crude tahini after microfluidization according to an exemplary embodiment of the invention as in FIG. 2A;

FIG. 3A is a plot of volume density % as a function of size in μm for “Har Bracha” crude tahini analyzed by laser diffraction (details of assay conditions are provided hereinbelow) using water as a dispersant;

FIG. 3B is a plot of volume density % as a function of size in μm for “Har Bracha” crude tahini after microfluidization according to an exemplary embodiment of the invention as in FIG. 3A;

FIG. 4A is a plot of volume density % as a function of size in μm for “Nesher” whole crude tahini analyzed by laser diffraction (details of assay conditions are provided hereinbelow) using water as a dispersant;

FIG. 4B is a plot of volume density % as a function of size in μm for “Nesher” whole crude tahini after microfluidization according to an exemplary embodiment of the invention as in FIG. 4A;

FIG. 5A is a plot of volume density % as a function of size in μm for “RIBUS rice bran extract” analyzed by laser diffraction (details of assay conditions are provided hereinbelow) using water as a dispersant;

FIG. 5B is a plot of volume density % as a function of size in μm for “RIBUS rice bran extract” (mixed with water 1:10, with the water containing the rice bran extract) after microfluidization according to an exemplary embodiment of the invention as in FIG. 5A;

FIG. 6 is a plot of volume density % as a function of size in μm for “powdered tahini” according to an exemplary embodiment of the invention analyzed by laser diffraction (details of assay conditions are provided hereinbelow) using water as a dispersant;

FIG. 7 is a simplified flow diagram of a method according to some exemplary embodiments of the invention;

FIG. 8 is a simplified flow diagram of a method according to some exemplary embodiments of the invention;

FIG. 9 is a photograph of samples of prepared tahini made from microfluidized crude tahini according to an exemplary embodiment of the invention and prepared tahini made from control crude tahini after heating;

FIG. 10 is a photograph of samples of microfluidized crude tahini according to an exemplary embodiment of the invention and control crude tahini at room temperature illustration their interaction with a glass container;

FIG. 11A is a plot of volume density % as a function of size in μm for whole grain crude tahini (Har Bracha) analyzed by laser diffraction (details of assay conditions are provided hereinbelow) using ISOPAR G as a dispersant; and

FIG. 11B is a plot of volume density % as a function of size in μm using ISOPAR G as a dispersant for the same whole crude tahini (Har Bracha) as in FIG. 11A after microfluidization according to an exemplary embodiment of the invention;

FIG. 11C is a plot of volume density % as a function of size in μm using laser diffraction with ISOPAR G as a dispersant for the same whole crude tahini (Har Bracha) as in FIG. 11A after microfluidization according to another exemplary embodiment of the invention;

FIG. 11D is a plot of volume density % as a function of size in μm using laser diffraction with ISOPAR G as a dispersant for the same whole crude tahini (Har Bracha) as in FIG. 11A after microfluidization according to still another exemplary embodiment of the invention;

FIG. 12 is a plot of volume density % as a function of size in μm using laser diffraction with ISOPAR G as a dispersant for liquefied pitted olives after microfluidization according to an exemplary embodiment of the invention.

FIG. 13 is a plot of volume density % as a function of size in μm for crude tahini Har Bracha 2 after microfluidization according to an exemplary embodiment of the invention analyzed by laser diffraction using ISOPAR G as a dispersant;

FIG. 14 is a plot of volume density % as a function of size in μm analyzed by laser diffraction using ISOPAR G as a dispersant for “Har Bracha 1” crude tahini after microfluidization according to an exemplary embodiment of the invention;

FIG. 15 is a plot of volume density % as a function of size in μm for microfluidized crude tahini Har Bracha 3 as in FIG. 13 analyzed by laser diffraction using ISOPAR G as a dispersant;

FIG. 16 is a simplified flow diagram of a method according to some exemplary embodiment's of the invention;

FIG. 17 is a simplified flow diagram of a method according to some exemplary embodiment's of the invention;

FIG. 18 is a plot of volume density % as a function of size in μm for “RGM SQUEEZE 3 supersal” crude tahini analyzed by laser diffraction (details of assay conditions are provided herein below) using Isopar G as a dispersant;

FIG. 19 is a plot of volume density % as a function of size in μm for “With hulls ROSHDI 2 SQUEEZE crude tahini analyzed by laser diffraction (details of assay conditions are provided herein below) using Isopar G as a dispersant; and

FIG. 20 is a plot of volume density % as a function of size in μm for “ROSHDI 1 SQUEEZE” crude tahini analyzed by laser diffraction (details of assay conditions are provide herein below) using Isopar G as a dispersant.

Source data for plots of volume density % as a function of size in μm is provided in an appendix at the end of the specification. This appendix is an integral part of the application.

### DETAILED DESCRIPTION OF EMBODIMENTS

Embodiments of the invention relate to improved crude tahini compositions and methods of producing them as well as to products and methods which employ other oily seeds (e.g. olives). Microfluidization is a common technical feature of many embodiments of the invention.

Specifically, some embodiments of the invention can be used to produce tahini characterized by a leftward shift in particle size distribution and/or an exceptionally long shelf life.

The principles and operation of compositions and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Overview

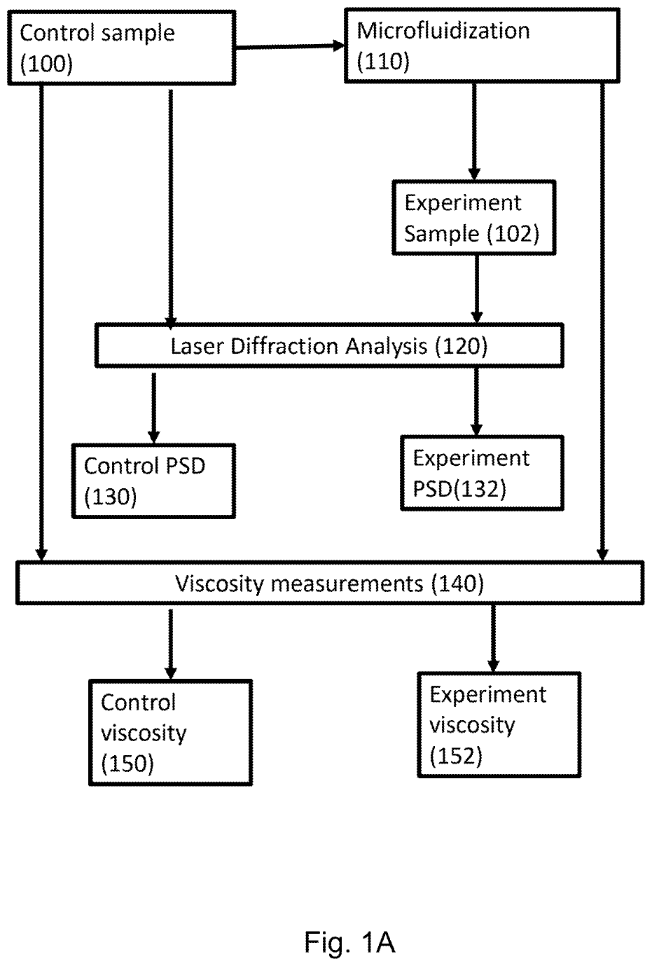

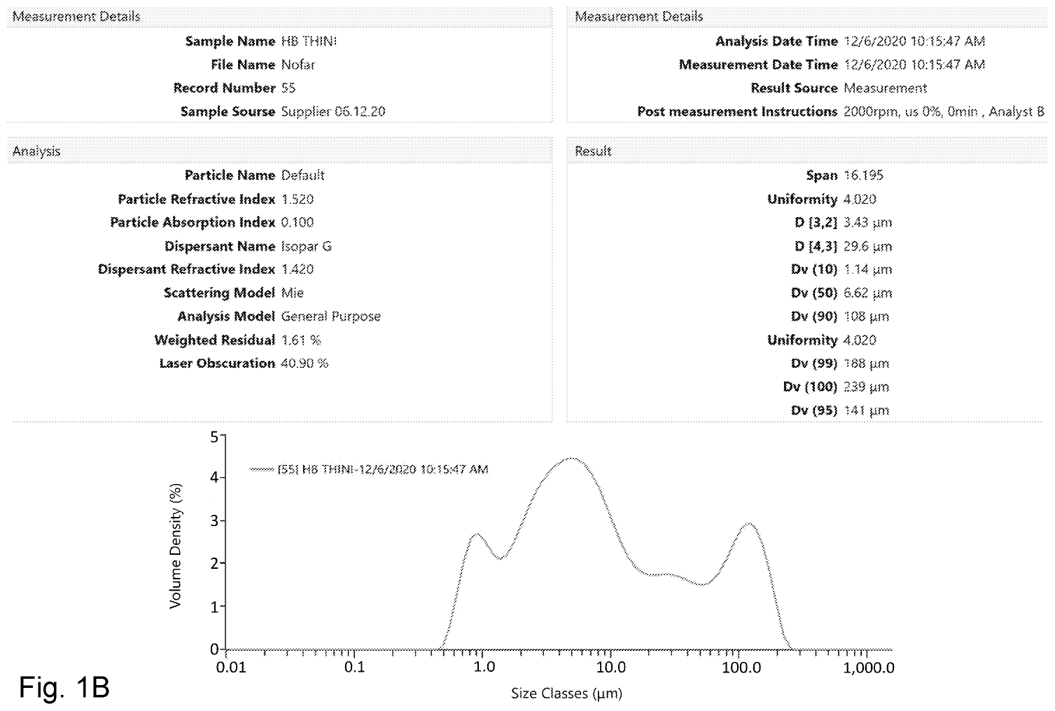

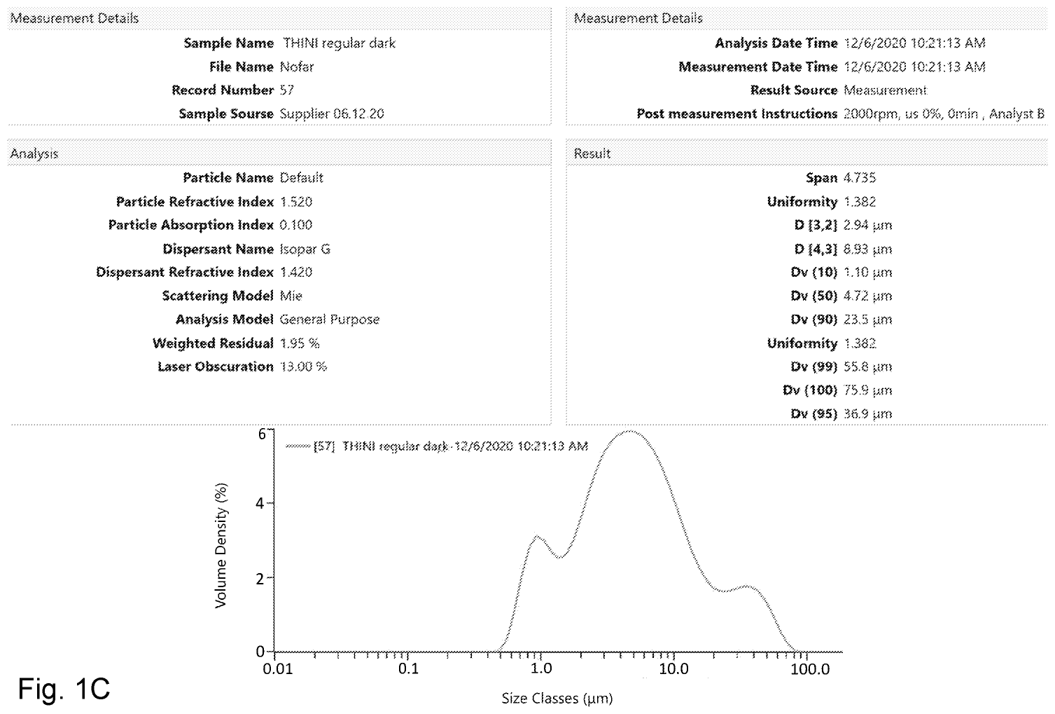

FIG. 1A is a simplified flow diagram of an analysis scheme according to some exemplary embodiments of the invention. FIG. 1A shows that a control sample 100 is microfluidized 110 to produce an experimental sample 102.

Samples 100 and 102 are each subjected to laser diffraction analysis 120 to produce control and experimental particle size distributions (PSD; 130 and 132 respectively).

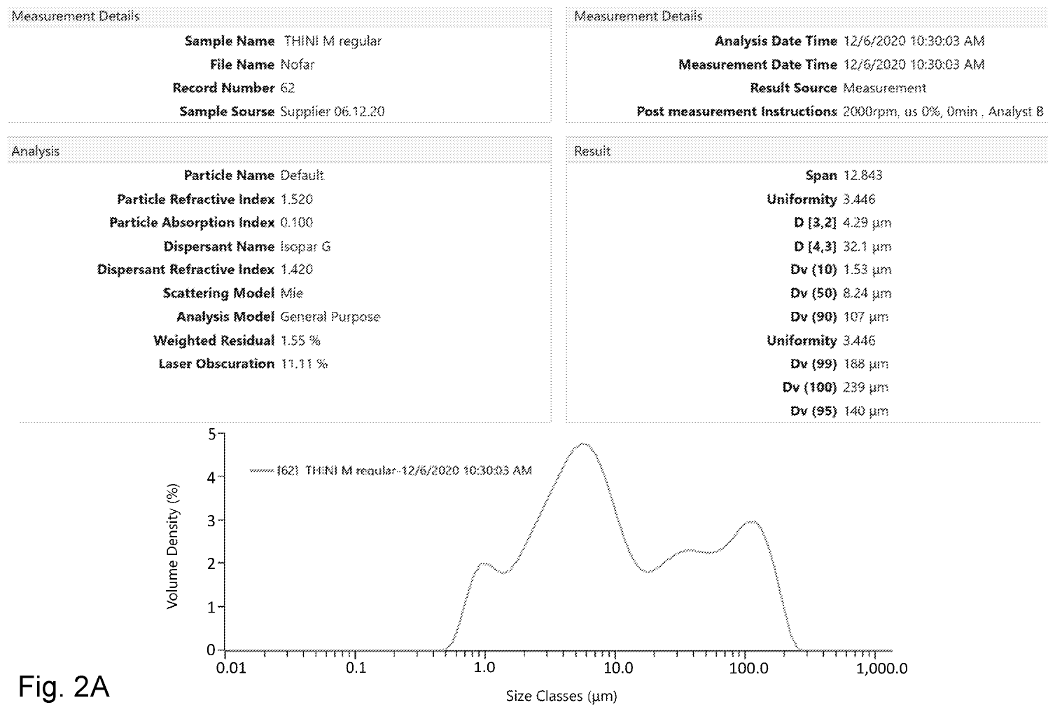

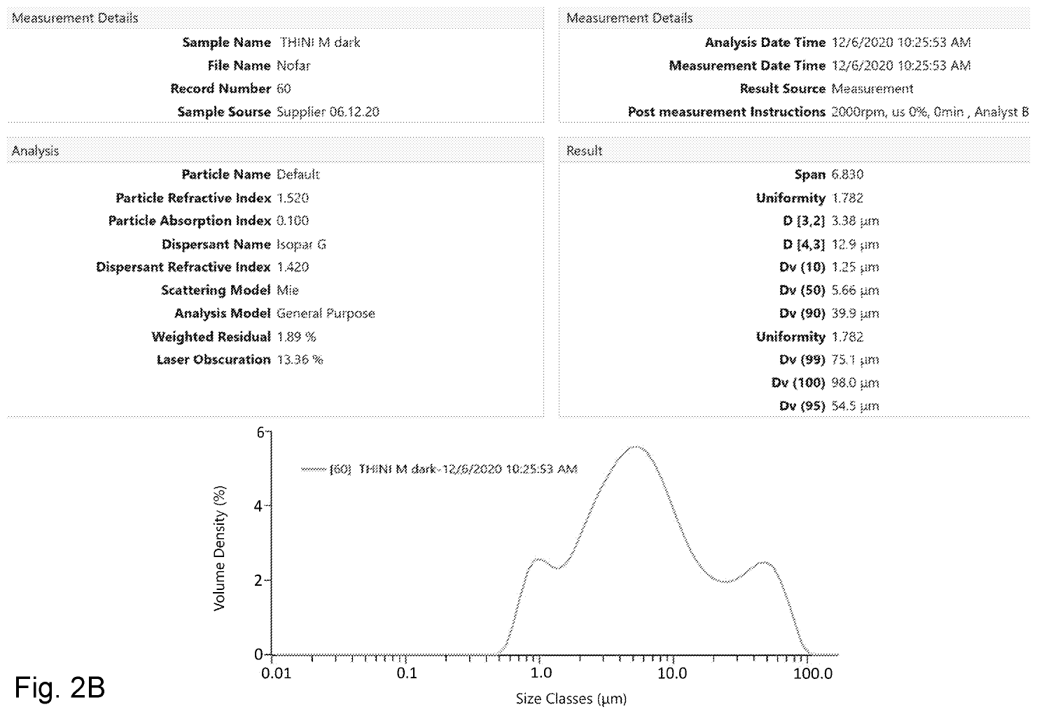

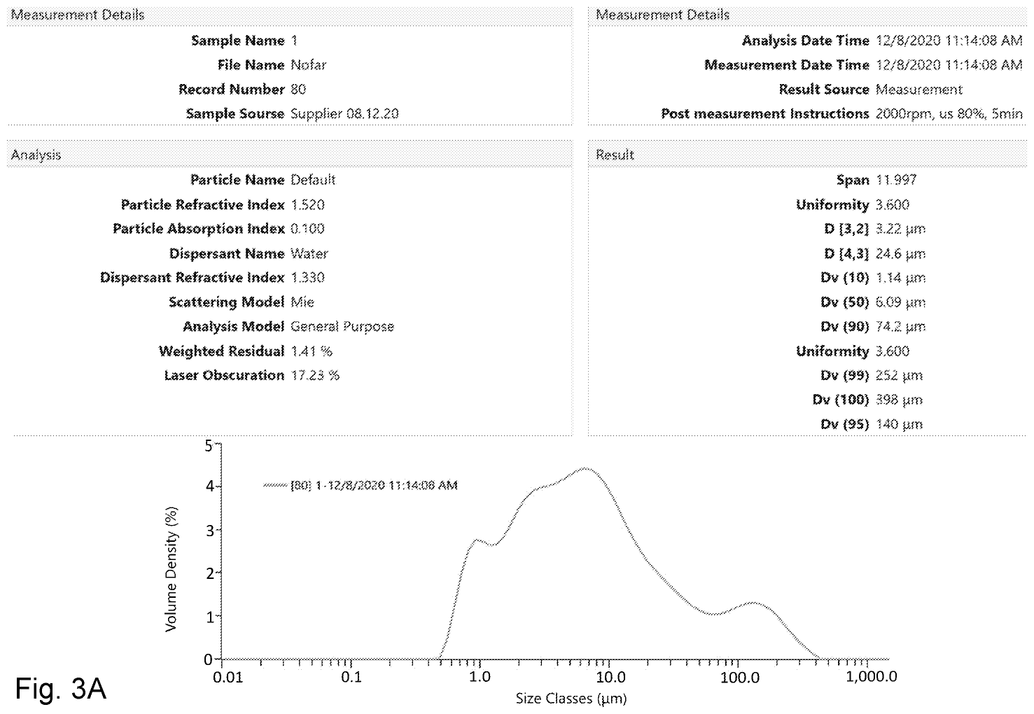

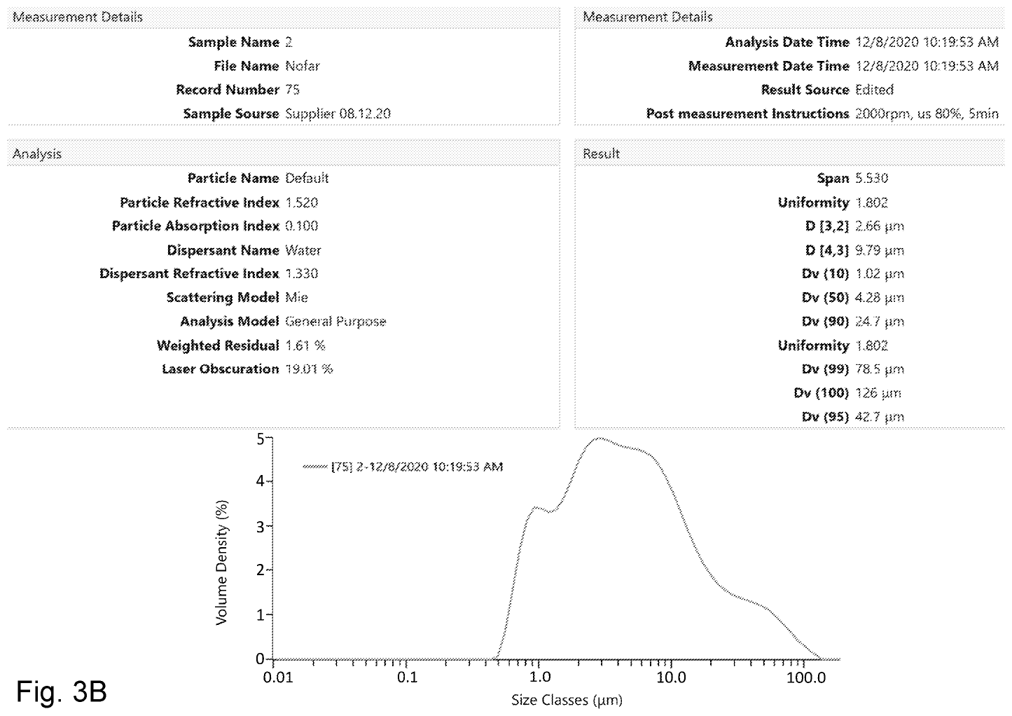

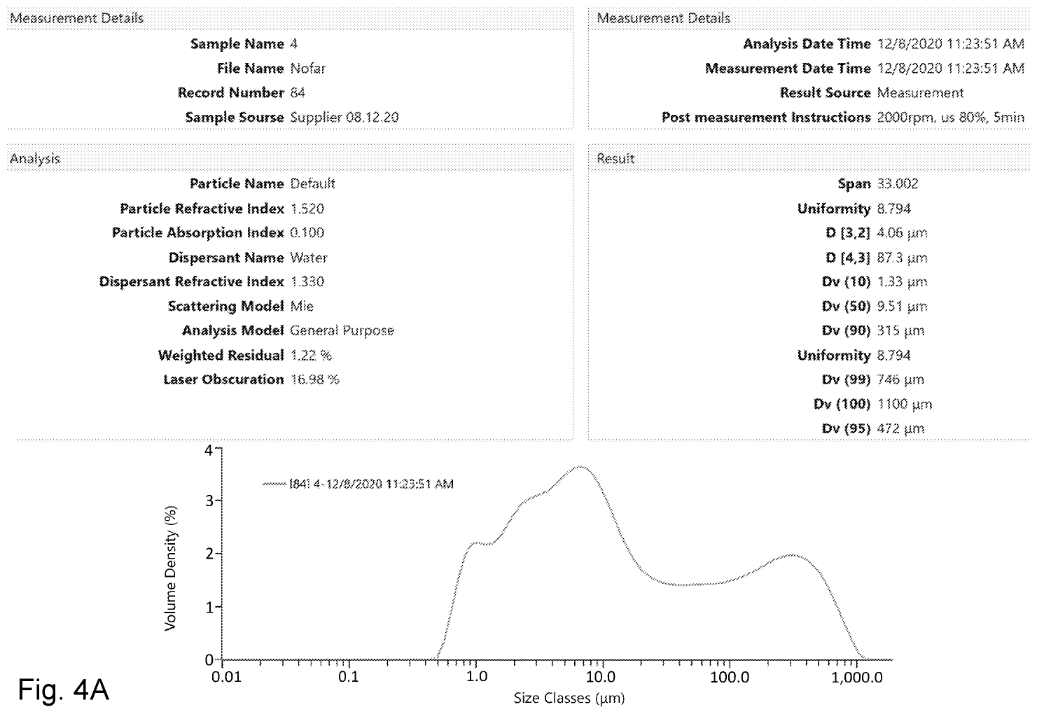

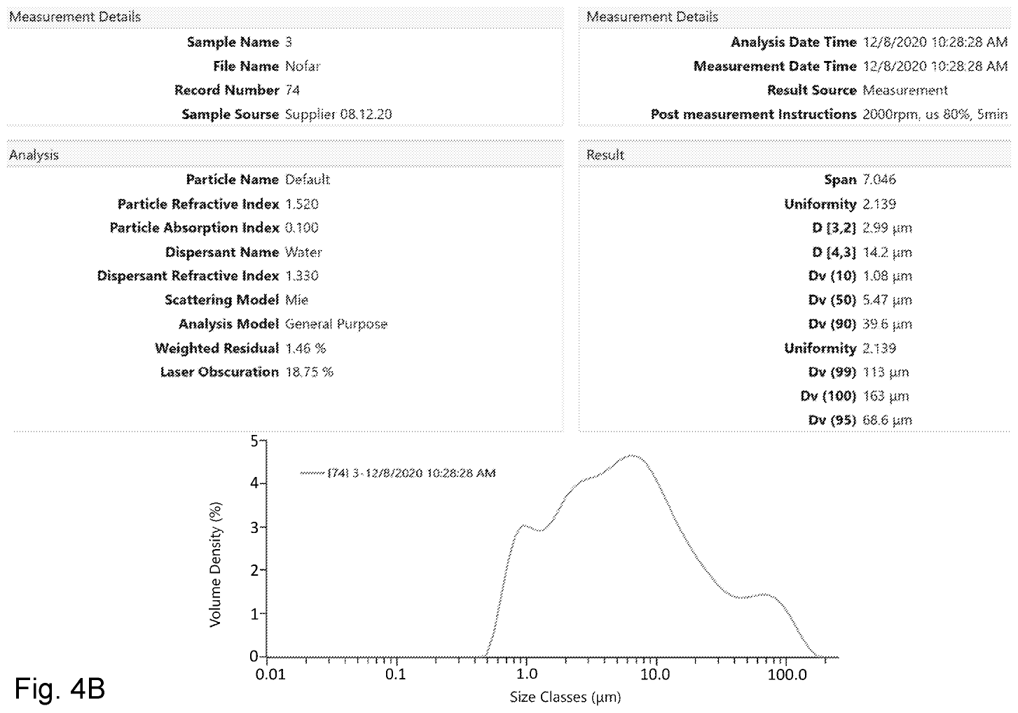

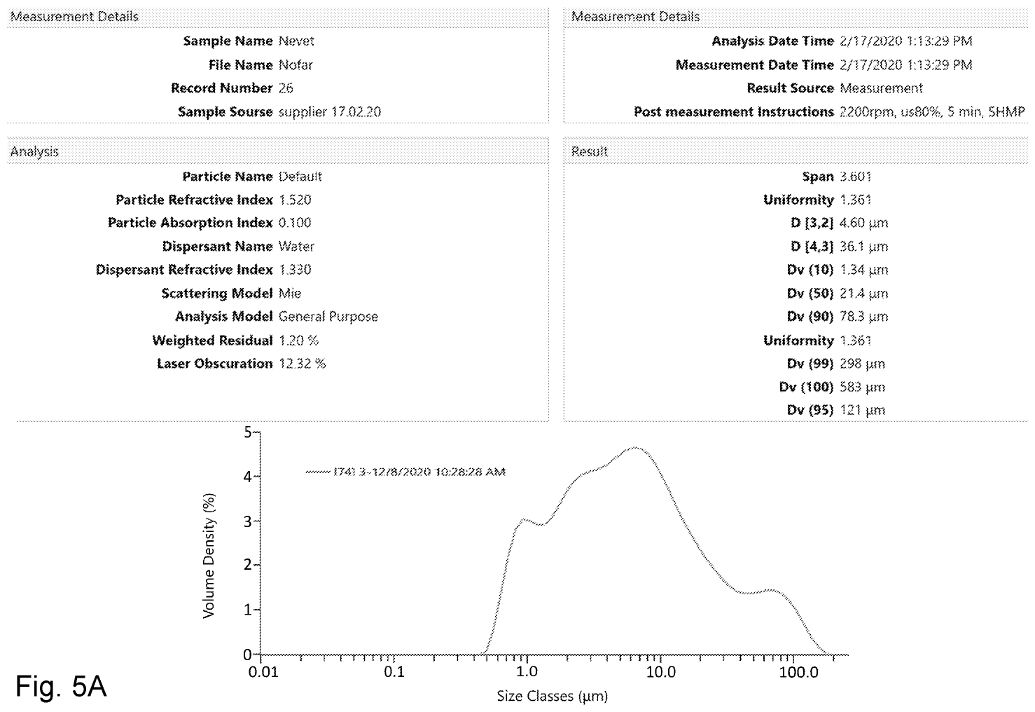

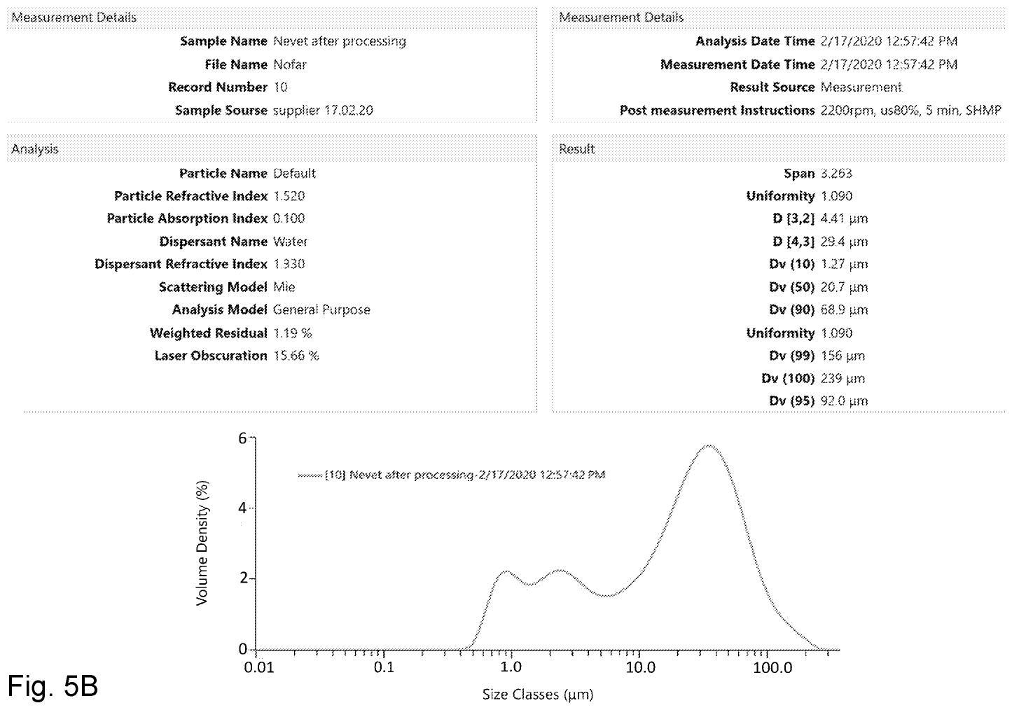

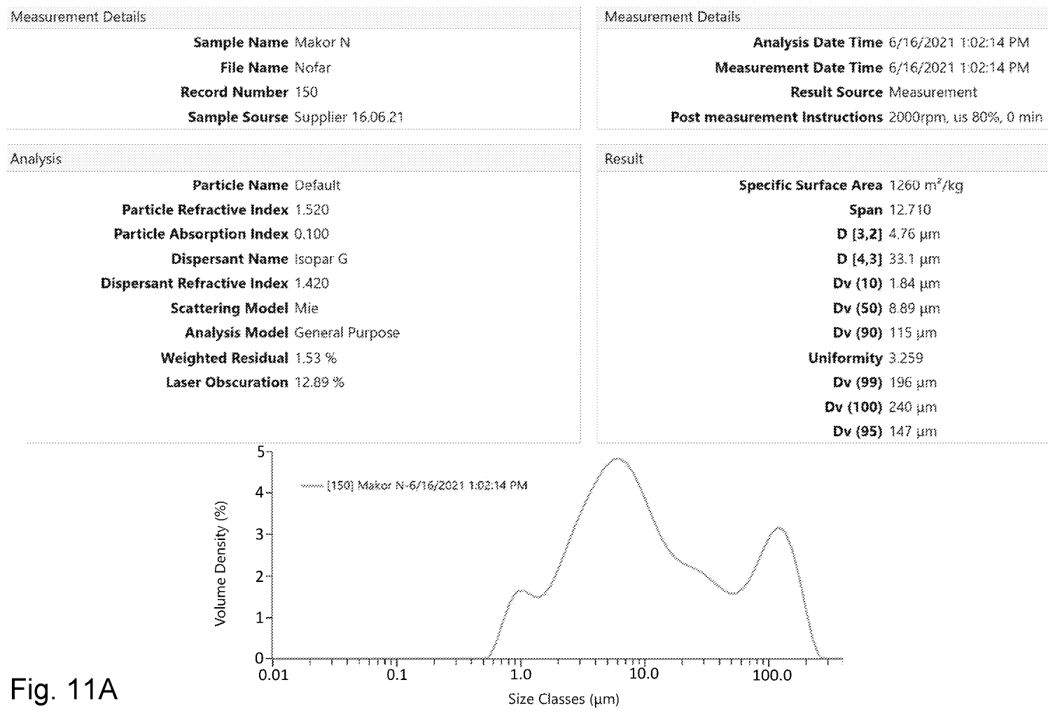

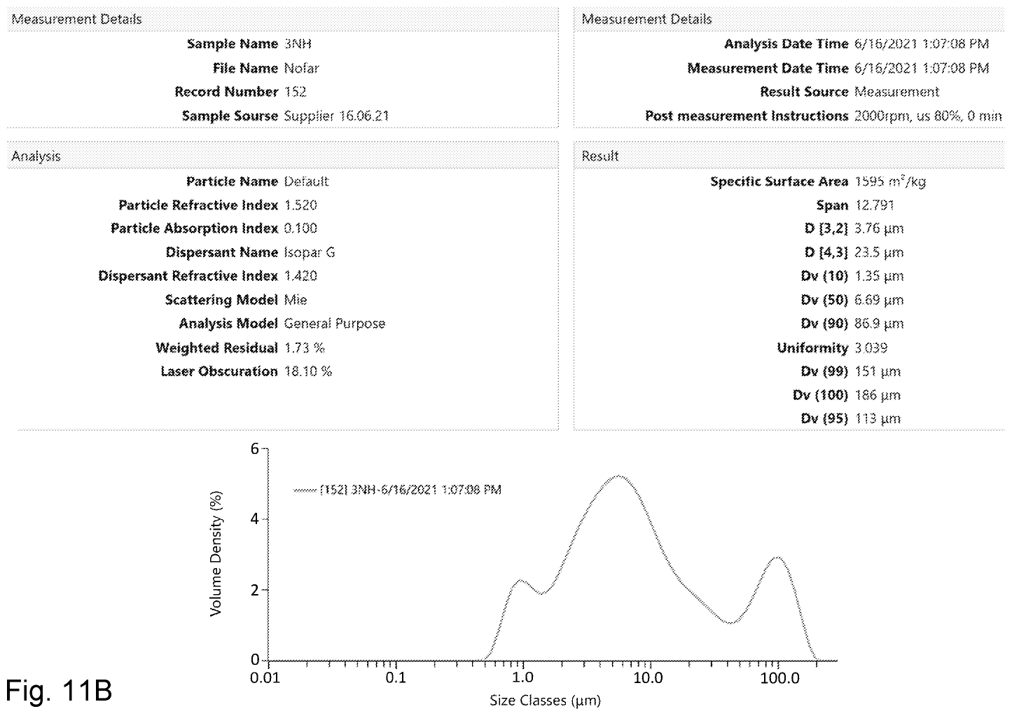

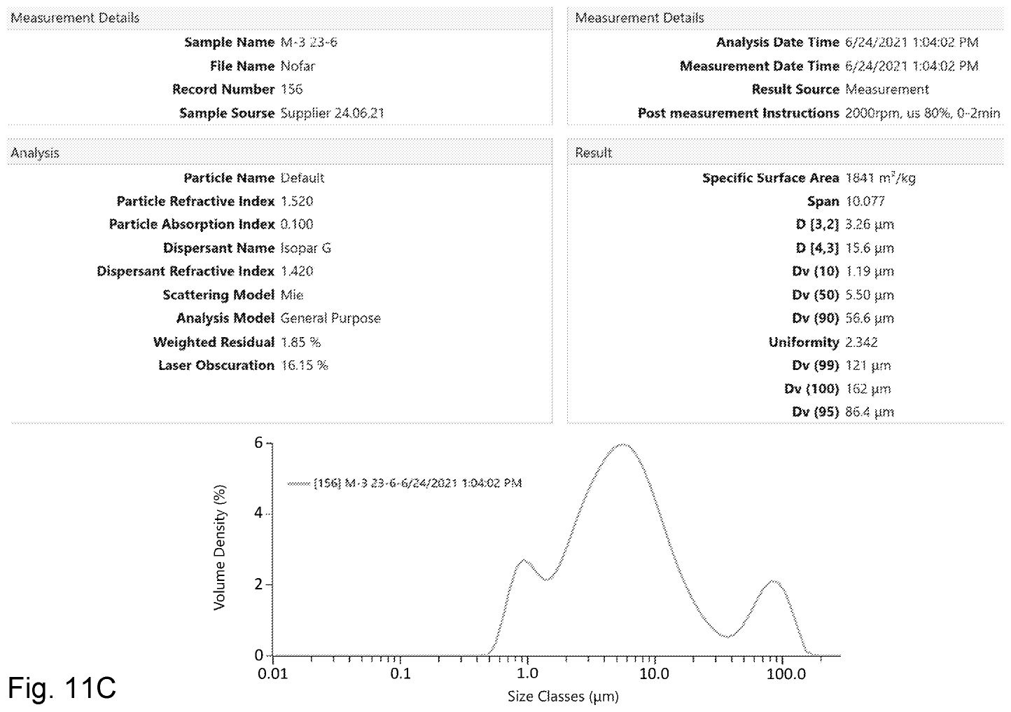

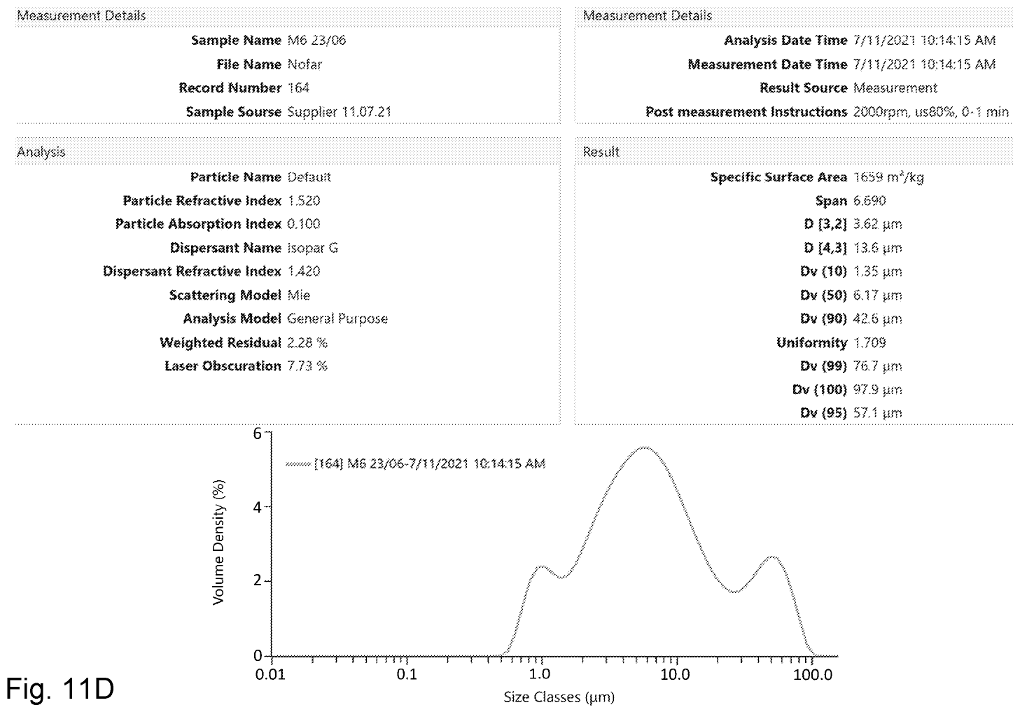

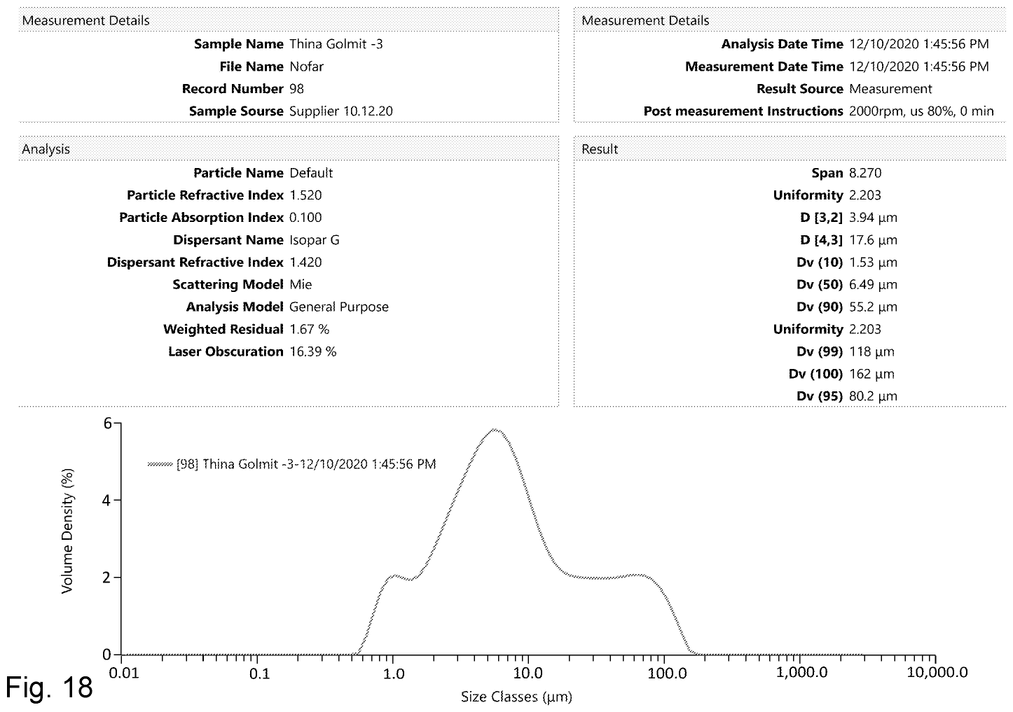

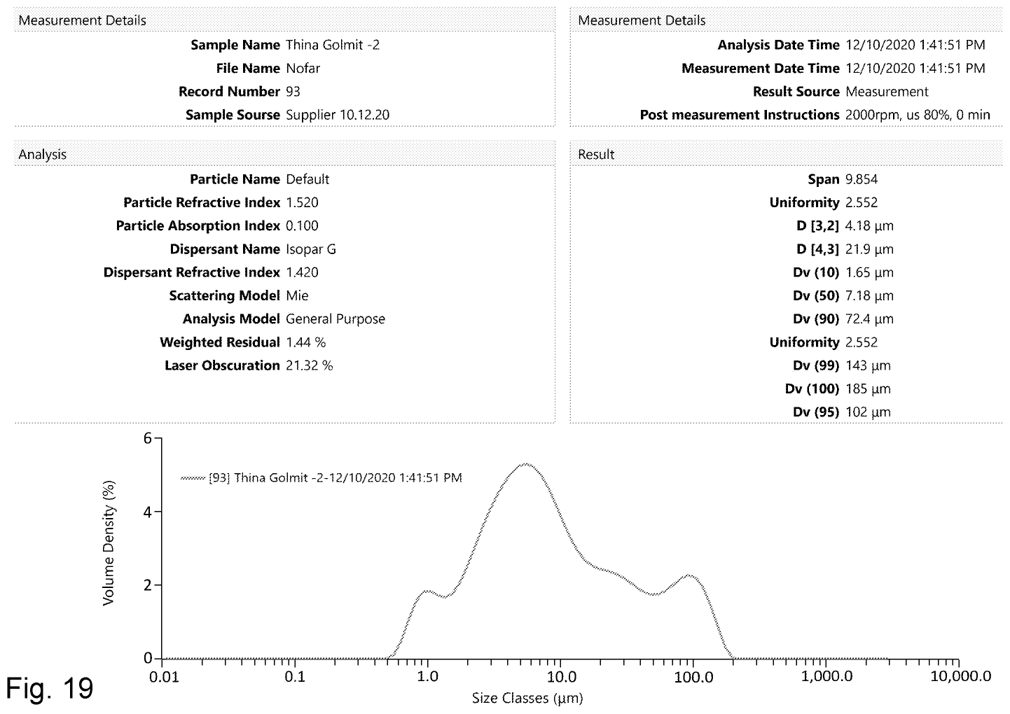

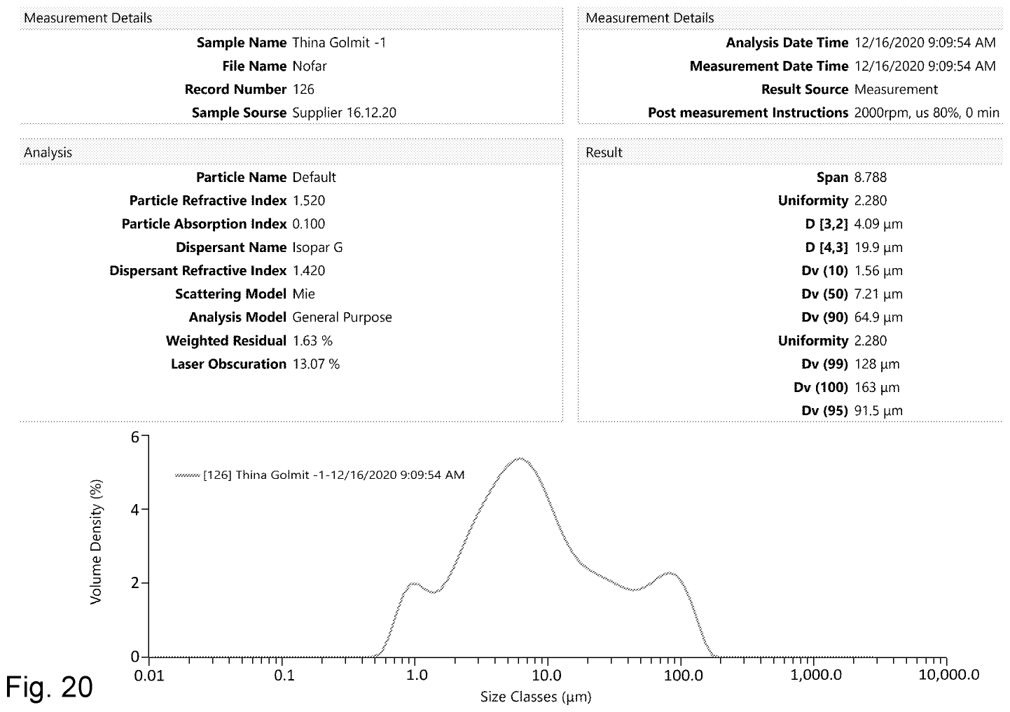

An exemplary microfluidization protocol 110 is presented hereinbelow. The laser diffraction analysis protocol 120 is presented hereinbelow. In the Figure set: FIG. 1B; FIG. 2A; FIG. 3A; FIG. 4A; FIG. 5A; FIG. 11A; FIG. 18; FIG. 19; and FIG. 20 depict control PSDs 130; and

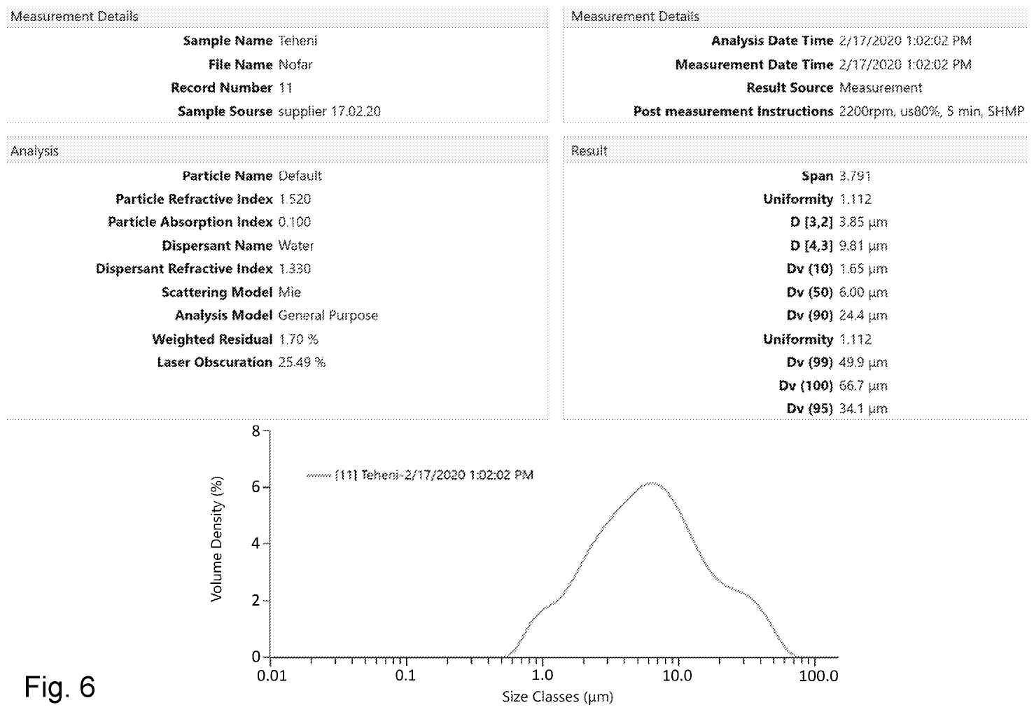

FIG. 1C; FIG. 2B; FIG. 3B; FIG. 4B; FIG. 5B; FIG. 6; FIG. 11B; FIG. 11C and FIG. 11D depict experimental PSDs 132.

Samples 100 and 102 were also subjected to viscosity measurements 140 to produce control viscosity data 150 and experimental viscosity data 152. PSD and viscosity data are summarized in tables 1 through 4.

TABLE 1
PSD of Microfluidized and control crude tahini using Isopar
G as a dispersant with corresponding viscosities
CONTROL

| | No Hulls | | | | | | | | |
|---|---|---|---|---|---|---|---|---|---|
| | | | | | | Viscosity CP SC4-21 (cP) | | | |
| | Particle Size Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |
| Har Bracha | 6.62 | 108 | 141 | 188 | 239 | 5750 | 2780 | 2268 | 2002 |
| Nesher Dak | 7.59 | 90 | 116 | 155 | 186 | ND | ND | ND | ND |
| Roshdi 1 squeeze | 7.21 | 64.9 | 91.5 | 128 | 163 | 3800 | 2110 | 1777 | 1602 |
| RGM 3 squeeze | 6.49 | 55.2 | 80.2 | 118 | 162 | 5900 | 3380 | 2845 | EEE |
| supersal | | | | | | | | | |
| MEAN | 6.98 | 79.53 | 107.2 | 147.3 | 187.5 | 5183.3 | 2756.7 | 2296.7 | 1802 |
| HIGH | 7.59 | 108 | 141 | 188 | 239 | 5750 | 3380 | 2875 | 2002 |
| LOW | 6.49 | 55.2 | 80.2 | 118 | 162 | 3800 | 2110 | 1777 | 1602 |
| | With Hulls | | | | | | | | |
| | | | | | | Viscosity CP SC4-21 (cP) | | | |
| | Particle Size Distribution (PSD) μm | | | | | 1 rpm | 5 rpm | 11 rpm | 22 rpm |
| | 50% | 90% | 95% | 99% | 100% | Shear1 | shear 5 | shear10 | shear20 |
| Nesher R | 8.24 | 107 | 140 | 188 | 239 | 10250 | 5480 | 4350 | EEE |
| Roshdi 2 squeeze | 7.18 | 72.4 | 102 | 143 | 185 | 3250 | 1730 | 1418 | 1259 |
| MEAN | 7.71 | 89.7 | 121 | 165.5 | 212 | 6750 | 3605 | 2884 | NA |
| HIGH | 8.24 | 107 | 140 | 188 | 239 | 10250 | 5480 | 4350 | NA |
| LOW | 7.18 | 72.4 | 102 | 143 | 185 | 3250 | 1730 | 1418 | NA |

Microfluidized

| | | | | | | Viscosity CP SC4-21 (cP) | | | |
|---|---|---|---|---|---|---|---|---|---|
| | Particle Size Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |

No Hulls

| | | | | | | | | | |
|---|---|---|---|---|---|---|---|---|---|
| ***Har Bracha 0 | 4.72 | 23.5 | 36.9 | 55.8 | 75.9 | 3700 | 1610 | 1232 | 1057 |
| **Har Bracha 1 | 5 | 29.5 | 46.8 | 72.5 | 97.9 | 2000 | 900 | 700 | 662.5 |
| *Har Bracha 2 | 3.75 | 10.2 | 12.3 | 15.9 | 18.7 | ND | ND | ND | ND |
| *Har Bracha 3 | 3.7 | 7.25 | 8.24 | 9.8 | 11.2 | 2950 | 1260 | 940 | 790 |
| MEAN | 4.30 | 17.61 | 26.06 | 38.5 | 50.933 | 2883 | 1257 | 957 | 837 |
| | | | | | | N = 3 | N = 3 | N = 3 | N = 3 |
| HIGH | 5 | 23.5 | 46.8 | 72.5 | 97.9 | 3700 | 1610 | 1232 | 1057 |
| LOW | 3.7 | 7.25 | 8.24 | 9.8 | 11.2 | 2000 | 900 | 700 | 662.5 |

With Hulls

| | | | | | | | | | | |
|---|---|---|---|---|---|---|---|---|---|---|
| Nesher | YES | 5.66 | 39.9 | 54.5 | 75.1 | 98 | 4100 | 1820 | 1295 | ND |

*Microfluidization in LAB-PILOT m110-EH3 2X (200 μm entrance/200 μm exit) followed by 2X (200 μm entrance/100 μm exit) at 20,000-25,000 PSI. The difference between the machines is only in their processing rate.
**Microfluidization in LAB-PILOT m110-EH3 2X (200 μm entrance/200 μm exit) followed by 1X (200 μm entrance/100 μm exit) at 20,000-25,000 PSI.
***Microfluidization in LAB-PILOT M-110P 1X (400 μm entrance/200 μm exit) followed by 2X (200 μm entrance/200 μm exit) followed by 3X (200 μm entrance/87μm exit)at 20,000-25,000 PSI. The difference between the machines is only in their processing rate.

TABLE 2
PSD of Microfluidized and control crude tahini using
water as a dispersant with corresponding viscosities

| | | | | | | Viscosity CP SC4-21 (cP) | | | |
|---|---|---|---|---|---|---|---|---|---|
| | Particle Sized Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |

Control

| | No Hulls | | | | | | | | |
|---|---|---|---|---|---|---|---|---|---|
| Har Bracha | 6.09 | 74.2 | 140 | 252 | 398 | 5750 | 2780 | 2268 | 2002 |
| Nesher Dak R | 5.82 | 51.9 | 99.5 | 196 | 309 | ND | ND | ND | ND |
| Roshdi R1 squeeze | 6.31 | 53.5 | 95.8 | 179 | 308 | 3800 | 2110 | 1777 | 1602 |
| RGM R 3 squeeze | 6.32 | 46.7 | 90.7 | 179 | 272 | 5900 | 3380 | 2845 | EEEE |
| supersal | | | | | | | | | |
| MEAN | 6.14 | 56.58 | 106.5 | 201.5 | 321.75 | 5183.3 | 2756.67 | 2296.67 | 1802 |
| HIGH | 6.32 | 74.2 | 140 | 252 | 398 | 5900 | 3380 | 2875 | 2002 |
| LOW | 5.82 | 46.7 | 90.7 | 179 | 272 | 3800 | 2110 | 1777 | 1602 |
| | With Hulls | | | | | | | | |
| Roshdi Whole | 6.43 | 68.6 | 117 | 182 | 271 | 3200 | 1730 | 1418 | 1259 |
| Grain 2 squeeze | | | | | | | | | |
| Nesher Whole | 9.51 | 315 | 472 | 746 | 1100 | 10250 | 5480 | 4350 | EEEE |
| Grain | | | | | | | | | |
| MEAN | 7.97 | 191.8 | 294.5 | 464 | 685.5 | 6725 | 3605 | 2884 | NA |
| HIGH | 9.51 | 315 | 472 | 746 | 1100 | 10250 | 5480 | 4350 | NA |
| LOW | 6.43 | 68.6 | 117 | 182 | 271 | 3200 | 1730 | 1418 | NA |

Microfluidized

| | | | | | | | | | |
|---|---|---|---|---|---|---|---|---|---|
| Har Bracha Regular | 4.28 | 24.7 | 42.7 | 78.5 | 126 | 2000 | 900 | 700 | 662.5 |
| Nesher Whole grain | 5.47 | 39.6 | 68.6 | 113 | 163 | 4100 | 1820 | 1295 | ND |

TABLE 3
PSD of powdered Microfluidized crude
tahini using water as a dispersant

| | 50% | 90% | 95% | 99% | 100% |
|---|---|---|---|---|---|
| material | μm | μm | μm | μm | μm |
| Tahini | 6.00 | 24.4 | 34.1 | 49.9 | 66.7 |
| Powder | | | | | |

No hulls

TABLE 4
PSD of rice bran extract with and without microfluidization

| material | Microfluidized? | 50% μm | 90%μ | 95% | 99% | 100% |
|---|---|---|---|---|---|---|
| Rice bran | NO | 21.4 | 78.3 | 121 | 298 | 583 |
| before | | | | | | |
| rice bran | YES | 20.7 | 68.9 | 92 | 156 | 239 |
| after | | | | | | |

### Exemplary Crude Tahini

FIG. 3A and FIG. 3B illustrate graphically the effect of microfluidization (110 in FIG. 1) on PSD of crude tahini as measured by laser diffraction using water as a dispersant. Results are summarized numerically in Table 2.

Some exemplary embodiments of the invention relate to a crude tahini composition characterized by a Particle Size Distribution (PSD) of 90% of less than 46 μm as measured by laser diffraction using a Malvern—Mastersizer 3000 Wet dispersion with Hydro EV cell with water as the dispersant. In some exemplary embodiments of the invention, the crude tahini composition is characterized by a Particle Size Distribution (PSD) of 90% of less than 36 μm, of less than 33 μm, of less than 30 μm, of less than 27 μm, of less than 25 μm, or lesser or intermediate sizes as measured by laser diffraction.

Alternatively or additionally, in some embodiments, the crude tahini composition is characterized by a Particle Size Distribution (PSD) of 95% of less than 90 μm as measured by laser diffraction. According to various exemplary embodiments of the invention, the crude tahini composition is characterized by a Particle Size Distribution (PSD) of 95% of 60 μm or less; 56 μm or less; 52 μm or less; 47 μm or less; 43 μm or less or intermediate or smaller sizes as measured by laser diffraction.

Alternatively or additionally, in some embodiments the crude tahini composition is characterized by a Particle Size Distribution (PSD) of 99% of less than 179 μm as measured by laser diffraction. According to various exemplary embodiments of the invention the crude tahini composition is characterized by a Particle Size Distribution (PSD) of 99% of 120 μm or less; 115 pm or less; 110 μm or less; 105 μm or less; 100 μm or less; 95 μm or less; 90 μm or less; 85 μm or less; 80 μm or less; 79 μm or less; or lesser or intermediate sizes as measured by laser diffraction.

Alternatively or additionally, in some embodiments the crude tahini composition is characterized by a Particle Size Distribution (PSD) of 100% of less than 272 μm as measured by laser diffraction. According to various exemplary embodiments of the invention, the crude tahini composition is characterized by a Particle Size Distribution (PSD) of 100% of 200 μm or less; 190 μm or less; 180 μm or less; 170 μm or less; 160 μm or less; 150 μm or less; 140 μm or less; 130 μm or less; 127 μm or less or intermediate or smaller sizes as measured by laser diffraction.

Alternatively or additionally, in some embodiments the crude tahini composition is characterized by a viscosity cP SC4-21 at 5 RPM of 2000; 1900; 1800; 1700; 1600; 1500; 1400; 1300; 1200; 1100; 1000; 900 or intermediate or smaller number of cP (centipoise).

Alternatively or additionally, in some embodiments the crude tahini composition is characterized by a viscosity cP SC4-21 at 11 RPM of less than 1776; 1700; 1600; 1500; 1400; 1300; 1200; 1100; 1000; 900; 800; 700 or intermediate or smaller numbers of cP.

### Exemplary Whole Crude Tahini

FIG. 4A and FIG. 4B illustrate graphically the effect of microfluidization (110 in FIG. 1) on PSD of crude tahini as measured by laser diffraction using water as the dispersant. Results are summarized numerically in Table 2.

Some exemplary embodiments of the invention relate to a whole grain crude tahini composition characterized by a Particle Size Distribution (PSD) of 90% of less than 68 μm as measured by laser diffraction using a Malvern—Mastersizer 3000 Wet dispersion with Hydro EV cell with water as the dispersant. According to various exemplary embodiments of the invention, the whole grain crude tahini composition is characterized by a Particle Size Distribution (PSD) of 90% of 50 μm; 48 μm; 46 μm; 44 μm; 42 μm; 40 μm or intermediate or smaller sizes.

Some exemplary embodiments of the invention relate to a whole grain crude tahini composition characterized by a Particle Size Distribution (PSD) of 95% of less than 117 μm as measured by laser diffraction. According to various exemplary embodiments of the invention, the whole grain crude tahini composition is characterized by a Particle Size Distribution (PSD) of 95% of 90 μm; 85 μm; 80 μm; 75 μm; 70 μm; 69 μm or intermediate or smaller sizes.

Some exemplary embodiments of the invention relate to a whole grain crude tahini composition characterized by a Particle Size Distribution (PSD) of 99% of less than 181 μm as measured by laser diffraction. According to various exemplary embodiments of the invention, the whole grain crude tahini composition is characterized by a Particle Size Distribution (PSD) of 99% of 150 μm; 145 μm; 140 μm; 135 μm; 130 μm; 125 μm; 120 μm; 115 μm; 113 μm or smaller or intermediate sizes.

Some exemplary embodiments of the invention relate to a whole grain crude tahini composition characterized by a Particle Size Distribution (PSD) of 100% of 270 μm or less as measured by laser diffraction. According to various exemplary embodiments of the invention, the whole crude tahini composition is characterized by a Particle Size Distribution (PSD) of 100% of 200 μm; 190 μm; 180 μm; 170 μm; 165 μm; 163 μm or intermediate or smaller sizes.

Some exemplary embodiments of the invention relate to a whole grain crude tahini composition characterized by a viscosity cP SC4-21 at 11 RPM of 1795, 1632, 1400; 1380; 1360; 1340; 1320; 1310; 1300; 1295 or intermediate or lower values.

Exemplary Crude Tahini with Different Dispersant

FIG. 1B and FIG. 1C illustrate graphically the effect of microfluidization (110 in FIG. 1) on PSD of crude tahini as measured by laser diffraction using Isobar G as the dispersant. Results are summarized numerically in Table 1.

Some exemplary embodiments of the invention relate to a crude tahini composition characterized by a Particle Size Distribution (PSD) of 90% of less than 55 μm as measured by laser diffraction using a Malvern—Mastersizer 3000 Wet dispersion with Hydro EV cell with Isopar G as the dispersant. According to various exemplary embodiments of the invention, the crude tahini composition is characterized by a Particle Size Distribution (PSD) of 90% of 40 μm; 35 μm; 30 μm; 28 μm; 26 μm; 24 μm or intermediate or smaller sizes.

Some exemplary embodiments of the invention relate to a crude tahini composition characterized by a Particle Size Distribution (PSD) of 95% of less than 80 μm as measured by laser diffraction. According to various exemplary embodiments of the invention, the crude tahini composition is characterized by a Particle Size Distribution (PSD) of 95% of 60 μm; 55 μm; 50 μm; 45 μm; 40 μm; 37 μm or intermediate or smaller sizes.

Some exemplary embodiments of the invention relate to a crude tahini composition characterized by a Particle Size Distribution (PSD) of 99% of less than 117 μm as measured by laser diffraction. According to various exemplary embodiments of the invention, the crude tahini composition is characterized by a Particle Size Distribution (PSD) of 99% of 90 μm; 80 μm; 70 μm; 60 μm; 56 μm; 55 μm or intermediate or smaller sizes.

Some exemplary embodiments of the invention relate to a crude tahini composition characterized by a Particle Size Distribution (PSD) of 100% of less than 160 μm as measured by laser diffraction. According to various exemplary embodiments of the invention, the crude tahini composition is characterized by a Particle Size Distribution (PSD) of 100% of 120 μm; 110 μm; 100 μm; 90 μm; 80 μm; 76 μm or intermediate or smaller sizes.

Some exemplary embodiments of the invention relate to a crude tahini composition characterized by a viscosity cP SC4-21 at 5 RPM of less than 2100; less than 2000; less than 1900; less than 1800; less than 1700; less than 1600; less than 1500; less than 1400; less than 1300; less than 1200; less than 1100; less than 1000; less than 900 or intermediate or lower values.

Some exemplary embodiments of the invention relate to a crude tahini composition characterized by a viscosity cP SC4-21 at 11 RPM of less than 1770; less than 1700; less than 1600; less than 1500; less than 1400; less than 1300; less than 1200; less than 1100; less than 1000; less than 900; less than 800; less than 700 or intermediate or lower values.

Exemplary Whole Crude Tahini with Different Dispersant

FIG. 2A and FIG. 2B illustrate graphically the effect of microfluidization (110 in FIG. 1) on PSD of whole crude tahini as measured by laser diffraction using Isopar G as dispersant. Results are summarized numerically in Table 1.

Some exemplary embodiments of the invention relate to a whole grain crude tahini composition characterized by a Particle Size Distribution (PSD) of 90% of less than 72.4 or less as measured by laser diffraction using a Malvern—Mastersizer 3000 Wet dispersion with Hydro EV cell with Isopar G as the dispersant. According to various exemplary embodiments of the invention, the whole grain crude tahini composition is characterized by a Particle Size Distribution (PSD) of 90% of 65 μm; 60 μm; 55 μm; 50 μm; 48 μm; 45 μm; 42 μm; 40 μm or intermediate or smaller sizes.

Some exemplary embodiments of the invention relate to a whole grain crude tahini composition characterized by a Particle Size Distribution (PSD) of 50% of less than 7 μm as measured by laser diffraction using a Malvern—Mastersizer 3000 Wet dispersion with Hydro EV cell with Isopar G as the dispersant. According to various exemplary embodiments of the invention, the whole grain crude tahini composition is characterized by a Particle Size Distribution (PSD) of 50% of 6.5 μm; 6.0 μm; 5.5 μm; 5.0 μm; 4.8 μm; 4.5 μm; 0.42 μm; 4.0 μm or intermediate or smaller sizes.

Some exemplary embodiments of the invention relate to a whole grain crude tahini composition characterized by a Particle Size Distribution (PSD) of 95% of less than 101 μm as measured by laser diffraction. According to various exemplary embodiments of the invention, the whole grain crude tahini composition is characterized by a Particle Size Distribution (PSD) of 95% of 80 μm; 75 μm; 70 μm; 65 μm; 60 μm; 55 μm or intermediate or smaller sizes.

Some exemplary embodiments of the invention relate to a whole grain crude tahini composition characterized by a Particle Size Distribution (PSD) of 99% of less than 143 μm as measured by laser diffraction. According to various exemplary embodiments of the invention, the whole grain crude tahini composition is characterized by a Particle Size Distribution (PSD) of 130 μm; of 120 μm; of 110 μm; of 100 μm; of 90 μm; of 80 μm; of 75 μm or intermediate or smaller sizes.

Some exemplary embodiments of the invention relate to a whole grain crude tahini composition characterized by a Particle Size Distribution (PSD) of 100% of less than 184 μm as measured by laser diffraction. According to various exemplary embodiments of the invention, the whole grain crude tahini composition is characterized by a Particle Size Distribution (PSD) of 100% of 165 μm; 160 μm; 150 μm; 140 μm; 130 μm; 120 μm; 110 μm; 105 μm; 100 μm; 98 μm or intermediate or smaller sizes.

Some exemplary embodiments of the invention relate to a whole grain crude tahini composition characterized by a viscosity cP SC4-21 at 11 RPM of less than 1417; less than 1400; less than 1350; less than 1325; less than 1300; less than 1295 or intermediate or lower values.

Results presented in table 1 relate to commercially available tahini labelled “whole grain”. However, it is believed that many of these products to not contain the full amount of hulls naturally present in sesame seeds. See table 5B for an analysis of “real” whole gain tahini with at least 13% crude fiber.

Exemplary Crude Tahini Prepared with an Alternate Microfluidization Protocols

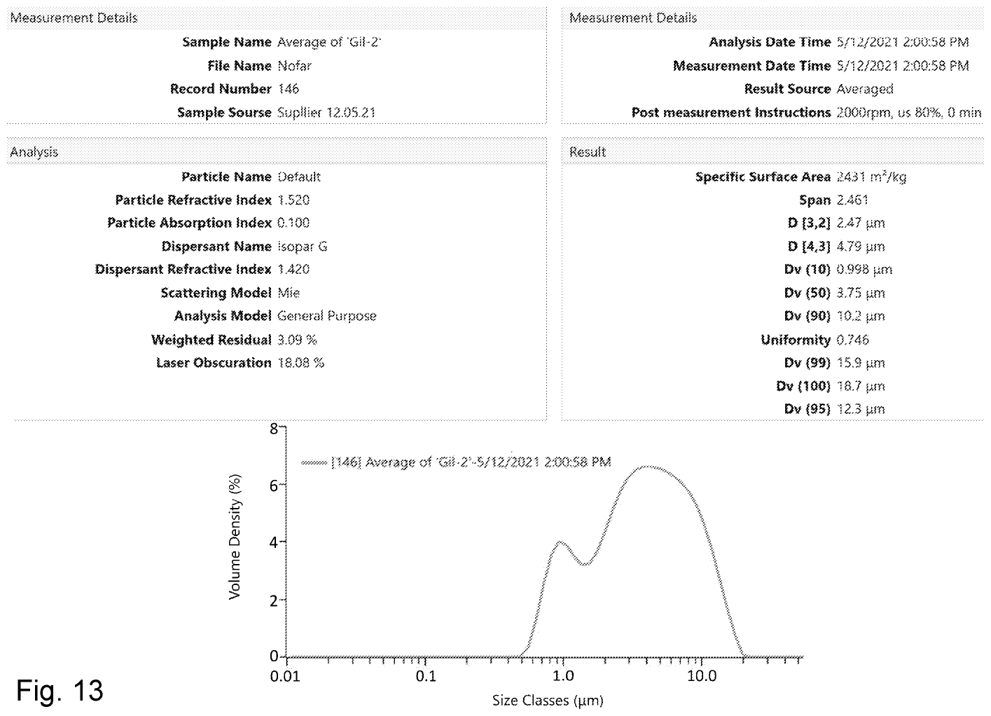

FIG. 13 is a plot of volume density % as a function of size in μm for crude tahini Har Bracha 2 after microfluidization according to an exemplary embodiment of the invention analyzed by laser diffraction using ISOPAR G as a dispersant.

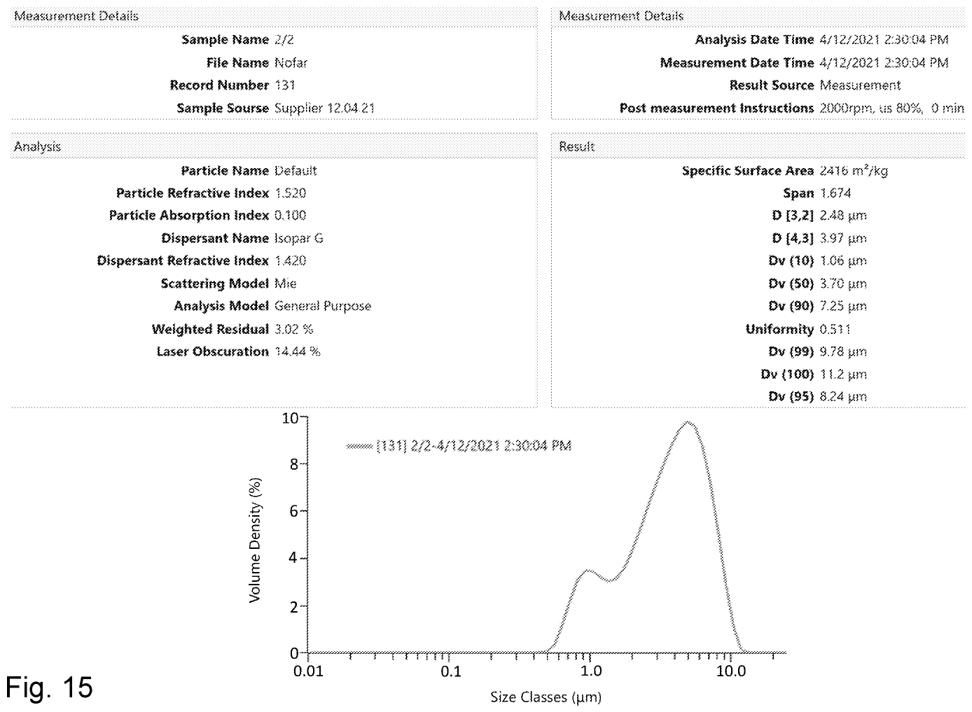

FIG. 15 is a plot of volume density % as a function of size in μm for another sample of the same microfluidized crude tahini Har Bracha 3 as in FIG. 13 analyzed by laser diffraction using ISOPAR G as a dispersant.

Har Bracha tahini was homogenized using a lab pilot m110EH30 at 22,00 PSI using 200 μm entrance/200 μm exit (2X) followed by 200 μm entrance/100 μm exit (2X).

PSD data from FIG. 13 is summarized numerically in Table 1 as Har Bracha 2. PSD data from FIG. 15 is summarized numerically in Table 1 as Har Bracha 3. Compare to pre-homogenization data for Har Bracha in Table 1.

FIG. 1C is a plot of volume density % as a function of size in μm for crude tahini Har Bracha (FIG. 1B) after microfluidization according to an exemplary embodiment of the invention analyzed by laser diffraction using ISOPAR G as a dispersant.

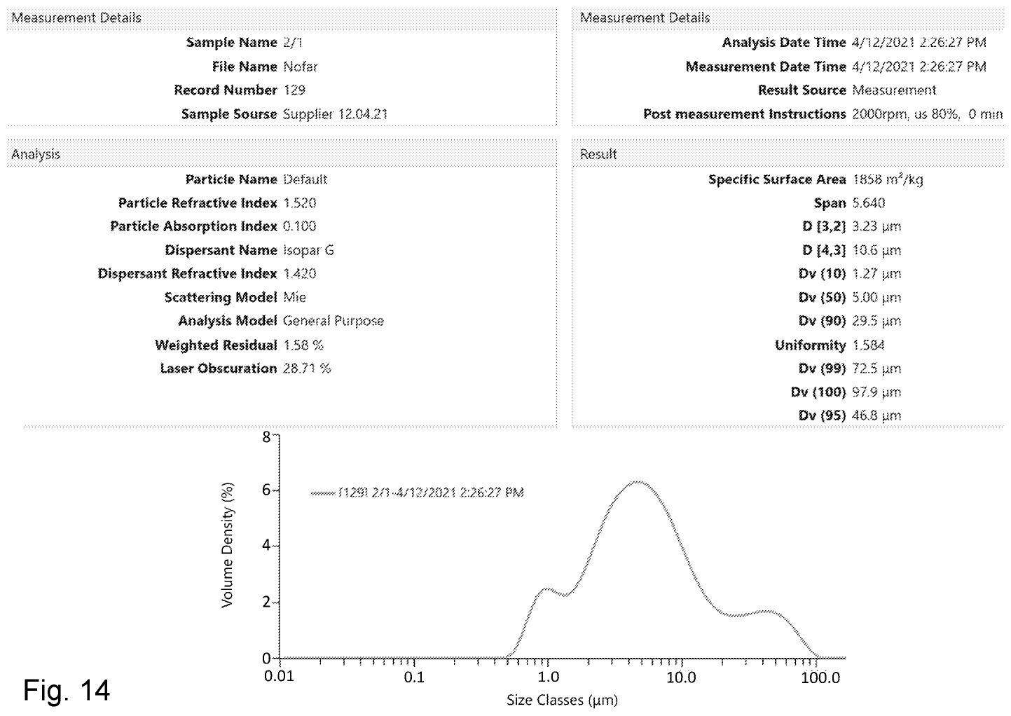

Har Bracha tahini was homogenized using a lab pilot m110EH30 at 22,00 PSI using 200 μm entrance/200 μm exit (2X) followed by 200 μm entrance/100 μm exit (1X). PSD data from FIG. 14 is summarized numerically in Table 1 as Har Bracha 1. Compare to pre-homogenization data for Har Bracha in Table 1 and the results of Har Bracha 2 in Table 1 (FIG. 13). The PSD in FIG. 14 has larger particle sizes than in FIG. 13 because the homogenization protocol included only 1 passage via 200 μm entrance/100 μm exit tube.

### Exemplary Method

Some exemplary embodiments of the invention relate to a method including microfluidizing crude tahini and/or whole grain crude tahini. According to various exemplary embodiments of the invention microfluidization is conducted at a pressure of 5,000 PSI (pounds per square inch); 10,000 PSI; 15,000 PSI; 20,000 PSI; 25,000 PSI; 30,000 PSI; 35,000 PSI, 40,000 PSI or intermediate or higher pressures. In some exemplary embodiments of the invention, the crude tahini includes whole crude tahini and/or regular crude tahini.

In some exemplary embodiments of the invention, the method includes preparing the crude tahini from sesame seeds. According to various exemplary embodiments of the invention preparing the crude tahini includes grinding in a ball mill and/or grinding with millstones and/or with a Reifiner Conche and/or Macintyre.

### Additional Exemplary Method

Some exemplary embodiments of the invention relate to a method of producing crude tahini including soaking sesame seeds in water for a minimum of 1 hour and grinding to produce tahini paste. According to various exemplary embodiments of the invention the soaking continues 2 hours; 3 hours; 4 hours; 5 hours; 6 hours; 7 hours; 8 hours; 9 hours; 10 hours or intermediate or longer times. In some embodiments soaking continues until sprouting is observed. Alternatively or additionally, in some embodiments soaking for an extended period of time contributes to production of GABA and/or sprouting.

In some exemplary embodiments of the invention, the method includes removing hulls from the sesame seeds. Alternatively or additionally, in some embodiments, the method includes roasting said sesame seeds. Alternatively or additionally, in some embodiments, the method includes microfluidizing the tahini paste. Alternatively or additionally, in some embodiments the method includes grinding the sesame seeds.

### Further Additional Exemplary Method

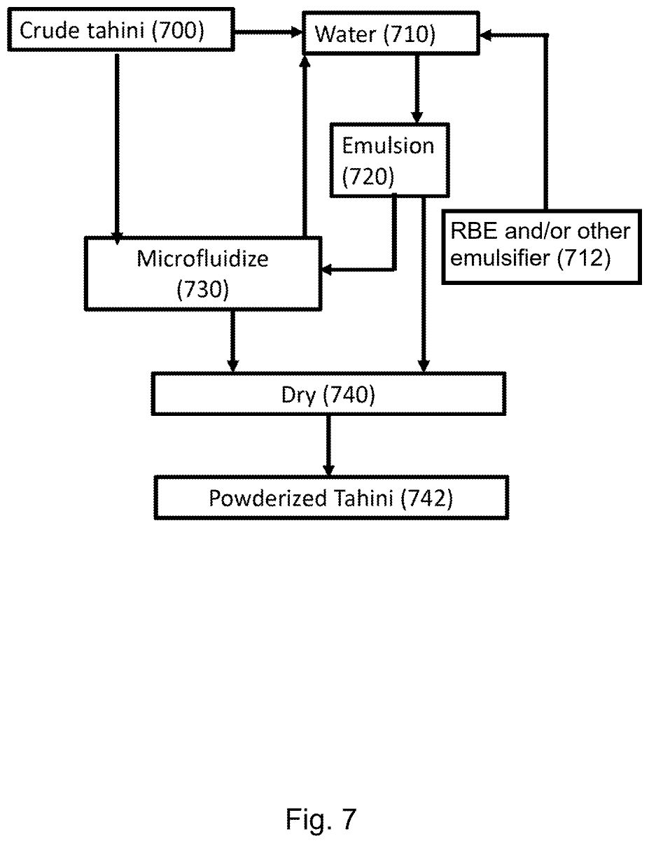

FIG. 7 is a simplified flow diagram of a method for powderizing tahini according to some exemplary embodiments of the invention. According to various exemplary embodiments of the invention the tahini is prepared from whole grain crude tahini or regular crude tahini.

Some exemplary embodiments of the invention relate to a method including mixing crude tahini 700 and water 710 to produce an emulsion 720 and microfluidizing 730.

According to various exemplary embodiments of the invention the microfluidization employs a pressure of 5000 PSI, 10,000 PSI, 15,000 PSI, 20,000 PSI, 25,000, PSI 30,000, PSI 35,000, PSI, 40,000 PSI or intermediate or greater pressures.

In some embodiment tahini 700 is mixed with water 710 to produce an emulsion 720 which is dried 740 without microfluidization 730.

In the depicted embodiment, the method includes drying 740 emulsion 720 to produce powderized tahini 742.

In some embodiments, the method includes dissolving rice bran extract (RBE; 712) ≤12%, ≤5%, ≤4%, ≤2% or intermediate or lower percentages of the weight of crude tahini 700 in water 710. In some exemplary embodiments of the invention, the RBE 712 is mixed with water 710. In some embodiments, the mixing is at high speed. In some embodiments water, 710 is heated, e.g. to 60° C., 65° C., 70° C. or intermediate or higher temperatures. In some embodiments the RBE solution is cooled. This RBE solution is then mixed with crude tahini 700.

In some embodiments drying 740 is spray drying. In some exemplary embodiments of the invention, the spray drying employs a dryer with an entrance temperature of 200° C. to 210° C. Alternatively or additionally, in some embodiments the spray drying employs a dryer with an exit temperature of 95° C. to 110° C.

See “exemplary spray drying equipment” hereinbelow for a discussion of how different parameters influence selection of spray drying temperatures.

Alternatively or additionally, in some embodiments drying 840 uses vacuum dryer or vacuum spray dryer.

Alternatively or additionally, in some embodiments drying 740 uses a vacuum dryer or vacuum spray dryer or Drum drier.

According to various exemplary embodiments of the invention, the vacuum dryer or vacuum spray dryer or drum dryer operates at an entrance temperature of 70° C., 60° C., 55° C., or intermediate or lower temperatures.

The method depicted in FIG. 7 covers four separate possibilities.

The first possibility is microfluidization 730 of crude tahini 700 followed by mixing with water 710 to form an initial emulsion 720 which is then microfluidized 730 again and then dried 740 to produce powderized tahini 742.

The second possibility is mixing crude tahini 700 with water 710 to produce emulsion 720 followed by microfluidization 730 and drying 740.

The third possibility is microlfluidizing 730 crude tahini and (in parallel or before) mixing water 710 with rice bran extract (712) <12% of the weight of crude tahini 700. In some embodiments, this mixture of water 710 and RBE 712 is heated, optionally boiled, and then cooled. The microfluidized tahini is then mixed with the water/RBE solution to produce an emulsion 720. In some embodiments, the emulsion 720 is microfluidized 730 then dried 740. In other exemplary embodiments of the invention, emulsion 720 is dried 740 directly. In either case, the result is powderized tahini 740.

The fourth possibility is mixing rice bran extract (RBE 712) <12% of the weight of crude tahini 700 with water 710. In some embodiments, this mixture of water 710 and RBE 712 is heated, optionally boiled, and then cooled. Crude tahini 700 is then added to the water/RBE mixture to produce an emulsion 720 which is either dried 740 directly, or microfluidized 730 and then dried 740. In either case, the result is powderized tahini 742.

In some exemplary embodiments of the invention, a decrease in temperature contributes to an improvement in rheology characteristics of powderized tahini 742. According to various exemplary embodiments of the invention, the rheology characteristics include flavor and/or aroma.

See “exemplary spray drying equipment” herein below.

### Exemplary Powdered Composition

Some exemplary embodiments of the invention relate to a powder composition including a spray-dried emulsion of crude tahini and water. In some embodiments the crude tahini and/or the emulsion are microfluidized. As described hereinabove in the context of FIG. 7, the composition is often powderized or granulated. In some embodiments, the composition includes rice bran extract. Alternatively or additionally, in some embodiments the composition includes seasonings and/or antioxidants and/or anticaking agents.

### Further Additional Exemplary Method

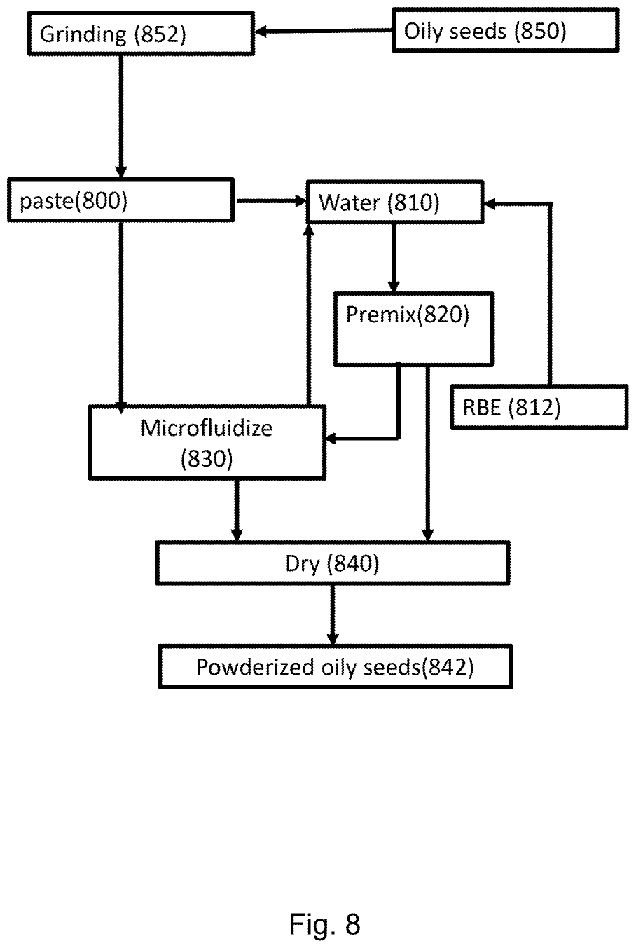

FIG. 8 is a simplified flow diagram of a method to produce powderized oily seeds according to an exemplary embodiment of the invention. According to various exemplary embodiments of the invention the seeds are provided with or without hulls.

FIG. 8 is a simplified flow diagram of a method to produce powderized oily seeds according to an exemplary embodiment of the invention. According to various exemplary embodiments of the invention the seeds are provided with or without hulls.

In some exemplary embodiments of the invention, paste 800 is mixed with water 810 to produce a pre-mix 820 and microfluidizing 830 paste 800 (either alone or as part of premix 820). According to various exemplary embodiments of the invention, the microfluidization 830 employs a pressure as described for microfluidization 730. In the depicted embodiment, the method includes grinding 852 the oily seeds 850 to produce a paste 800. In some embodiments the seeds are dried and/or roasted.

In some exemplary embodiments of the invention, paste 800 and water 810 are combined to form premix 820 which is dried 840 directly without microfluidization 830.

In the depicted embodiment, the method includes drying 840 premix 820 to produce powderized oily seeds 842.

In some embodiments, the method includes dissolving rice bran extract (RBE; 812) ≤12%; ≤5%, ≤4%, ≤3%, ≤2% or intermediate or lower percentages of the weight of paste 800 in water 810. In some exemplary embodiments of the invention, the RBE 812 is mixed with water 810 at high speed. In some embodiments water 810 is heated, e.g. to 60° C., 65° C., 70° C. or intermediate or greater temperatures. In some embodiments the RBE solution is cooled. This RBE solution is then mixed with crude paste 800.

In some embodiments drying 840 is spray drying. In some exemplary embodiments of the invention, the spray drying employs a dryer with an entrance temperature of 200° C. to 210° C.

Alternatively or additionally, in some embodiments the spray drying employs a dryer with an exit temperature of 95° C. to 110° C.

See “exemplary spray drying equipment” hereinbelow.

Alternatively or additionally, in some embodiments drying 840 uses a vacuum dryer or vacuum spray dryer or drum dryer. According to various exemplary embodiments of the invention, the vacuum dryer operates at an entrance temperature of 70° C., 60° C., 55° C., or intermediate or lower temperatures. In some exemplary embodiments of the invention, a decrease in temperature contributes to an improvement in rheology characteristics of powderized oily seeds 842. According to various exemplary embodiments of the invention, the rheology characteristics include flavor and/or aroma.

See “exemplary spray drying equipment” hereinbelow. The method depicted in FIG. 8 covers four separate possibilities.

The first possibility is microfluidization 830 of paste 800 followed by mixing with water 810 to form a premix 820 which is then microfluidized 830 and then dried 840 to produce powderized oily seeds 842.

The second possibility is mixing paste 800 with water 810 to produce premix 820 followed by microfluidization 830 and drying 840.

The third possibility is microfluidizing 830 paste 800 and (in parallel) mixing water 810 with rice bran extract (812) <12% of the weight of paste 800. In some embodiments, this mixture of water 810 and RBE 812 is heated, optionally boiled, and then cooled. The microfluidized paste 800 is then mixed with the water/RBE solution to produce premix 820. In some embodiments, the premix 820 is microfluidized 830 then dried 840. In other exemplary embodiments of the invention, premix 820 is dried 740 directly. In either case, the result is powderized oily seeds 842.

The fourth possibility is mixing rice bran extract (RBE 712) <12% of the weight of paste 800 with water 810. In some embodiments, this mixture of water 810 and RBE 812 is heated, optionally boiled, and then cooled. Paste 800 is then added to the water/RBE mixture to produce premix 820 which is either dried 840 directly, or microfluidized 830 and then dried 840. In either case, the result is powderized oily seeds 842.

### Further Additional Exemplary Composition

Some exemplary embodiments of the invention relate to a powder composition including a spray-dried homogenate of oily seeds and water. In some embodiments the homogenate is microfluidized prior to drying. In some embodiments, the powder composition includes rice bran extract and/or another emulsifier.

In other exemplary embodiments of the invention, other emulsifiers such as lecithin or monoglycerides or diglycerides or TWEEN or saponin or polysorbate are used instead of RBE or together with RBE.

Alternatively or additionally, in some embodiments the powder composition includes seasonings and/or antioxidants and/or anticaking agents.

### Characterization by Viscosity

In some exemplary embodiments of the invention there is provided a crude tahini composition with a viscosity cP SC4-21 at 5 RPM of 2000, 1700, 1500 or intermediate or lower values or less. Alternatively or additionally, in some embodiments there is provided a crude tahini composition having a viscosity cP SC4-21 at 11 RPM of less than 1796, less than 1700, less than 1633, less than 1400, less than 1000 or intermediate or lower values.

In some exemplary embodiments of the invention there is provided a whole grain crude tahini composition having a viscosity cP SC4-21 at 11 RPM of 1400 or less, 1300 or less or intermediate or lower values.

Viscosity data for conventional tahini as well as tahini according to exemplary embodiments of the invention is presented hereinabove in Table 1 and Table 2.

Adding 100 g of water to 100 g of microfluidized tahini will produce a much lower viscosity than similar dilution of tahini which was not microfluidized. One possible explanation for this observation is that the lower viscosity of the microfluidized crude tahini contributes to a lower viscosity of the emulsion. As a result, in some embodiments the microfluidized tahini is characterized by a lower starchiness as perceived by human tasting panels relative conventional crude tahini. This lower viscosity of the water:tahini emulsion persists for only a few seconds to a few minutes after mixing.

### Exemplary Rheology Considerations

Rheology panels indicate that many people perceive micro fluidized tahini paste sweeter than comparable tahini paste which was not subject to micro fluidization.

Microfluidized crude tahini exhibits different properties than standard tahini during emulsion preparation. This is apparent when mixing 50 g crude tahini with 30 g water. Standard tahini becomes viscous almost immediately upon mixing. Microfluidized tahini remains thin for 5 to 6 seconds after mixing and then increases in viscosity. A tasting panel of 10 people indicated microfluidized crude tahini does not become viscous in the mouth when mixed with saliva as regular Tahini does. Alternatively or additionally, microlfluidize crude tahini is sweeter than the crude tahini before microfluidization.

In some exemplary embodiments of the invention there is provided a crude tahini composition which is perceived in organoleptic testing as not becoming sticky in the mouth even after mixing with saliva.

### Exemplary Microfluidization Equipment

Microfluidization equipment suitable for use in the context of various exemplary embodiments of the invention is available from MICROFLUIDICS INTERNATIONAL CORPORATION (Westwood Mass., USA).

For example, model LM 10 provides up to 23,000 psi, LM 20, LV1, M110P, M110-EH-30, M110-EH-305, M815 Pilot Scale and M 700 each provide up to 30,000 psi. The M 710 provides up to 40,000 psi.

B.E.E. International Inc. (Easton, Mass., USA) also makes microfluidization equipment suitable for use in the context of various exemplary embodiments of the invention, such as the “Micro DeBEE” model.

Microfluidization is a high-shear fluid process, which provides uniform size reduction. In general, an increase in the amount of pressure applied by microfluidizing equipment contributes to a reduction in average particle size.

### Exemplary Microfluidization Protocol

A microfluidization machine as described above is rinsed with propanol then flushed with sunflower oil at 20,000 PSI. An additional wash with cold-pressed sesame oil at 20,000 PSI is conducted. Crude Tahini (or another sample) is mixed by rolling the container and 2X 200CC samples are taken in cups. Each sample is mixed with a blender until it appears homogenized to produce an initial homogenate.

A sample of the initial homogenate is loaded into the microfluidizer. A homogenization channel with a 400-micron inlet and 200-micron outlet is fitted and three passages are performed at 25000 PSI. For purposes of this specification and the accompanying claims, the term “homogenization channel” indicates a straight channel.

The processed material is cooled in a heat diffuser submerged in cold water

Exit temperature is 50° C. +5 degrees.

A homogenization channel with a 200-micron inlet and 87-micron outlet is fitted and three additional passages are performed at 25000 PSI.

The processed material is cooled in a heat diffuser submerged in cold water

Exit temperature is 50° C. +5 degrees.

For whole grain crude tahini samples, the second round of microfluidization is performed with a homogenization channel with a 200-micron inlet and 100-micron outlet is fitted and three additional passages are performed at 25000 PSI. Possibly at this stage, it can pass through a homogenization channel with a 200-micron inlet and 87-micron outlet.

Resultant microfluidized crude tahini (e.g. 102 in FIG. 1A) is watery in consistency and does not stick to the walls of containers. It appears like a nano-liquid and not like conventional crude tahini.

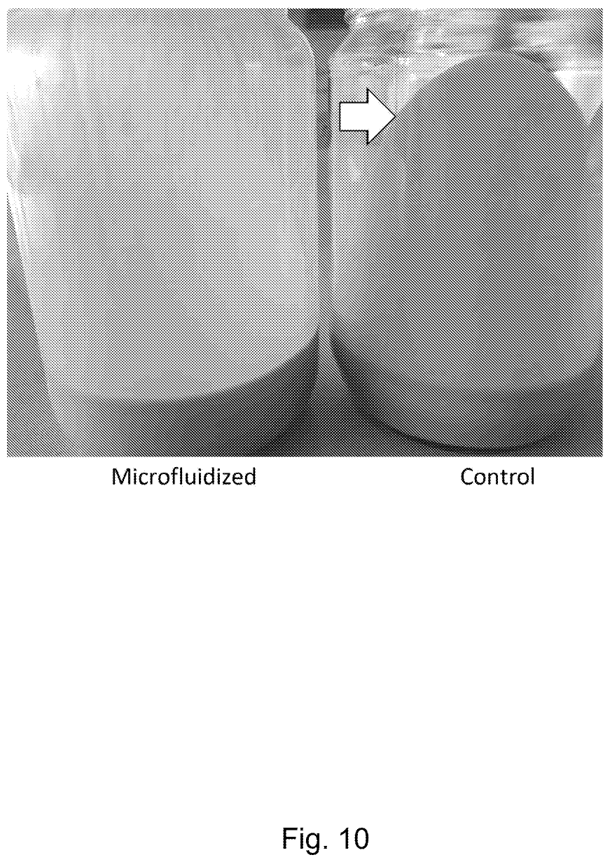

FIG. 10 is a photograph of samples of microfluidized crude tahini according to an exemplary embodiment of the invention and control crude tahini at room temperature illustrating their interaction with a glass container. Prior to acquisition of the photograph the glass containers were laid on their sides then raised again to standing position. The control crude tahini in the right container left a thick layer (indicated by white arrow) adhering to the glass. In comparison, the microfluidized crude tahini left only a thin film on the glass.

### Processing of Whole Grain Tahini Using Additional Exemplary Microfluidization Protocols

Whole grain sesame seeds were soaked in water for 3 hours then roasted and ground into tahini using a ball mill. A stone mill or conche or Maclntyre could be substituted. This preserves the natural ratio of hulls:seeds of 7% to 19% on a dry matter basis. In contrast, tahini indicated as “with hulls” in Table 1 and Table 2 (above) is labeled as “whole grain” by the manufacturer but may not contain the natural ratio of hulls: seeds. The resulting whole grain tahini was processed in a MICROFLUIDICS M-110-P homogenizer as described in the preceding section with the changes presented in Table 5A and analyzed for PSD and viscosity using protocols presented hereinbelow.

TABLE 5A
exemplary microfluidization protocols

| | | channel | Number | |
|---|---|---|---|---|
| | Prev. | Inlet/outlet | of | |
| Protocol | Protocol | (microns) | passages | Pressure PSI |
| A | none | 400/200 | 2 | 20,000 |
| B | A | 200/100 | 3 | 20,000 |
| C | B | 200/100 | 3 | 20,000-22,000 |
| D | C | 200/100 | 3 | 20,000-22,000 |

The resultant microfluidized tahini had even lower viscosity than that shown in FIG. 10.

FIG. 11A shows particle size distribution of the Tahini before microfluidization.

FIG. 11B shows particle size distribution of the Tahini after microfluidization According to protocol B of Table 5A.

FIG. 11C shows particle size distribution of the Tahini after microfluidization According to protocol C of Table 5A.

FIG. 11D shows particle size distribution of the Tahini after microfluidization According to protocol D of Table 5A.

PSD data from FIG. 11A, FIG. 11B, FIG. 11C, and FIG. 11D are summarized in Table 5B together with corresponding viscosity data.

TABLE 5B
PSD of crude Tahini with full hulls before and after Microfluidization
according to the protocols presented in Table 5A using Isopar G
as a dispersant and corresponding Viscosity CP SC4-21 (cP) data.

| | | | | | | | Viscosity CP SC4-21 (cP) | | | |
|---|---|---|---|---|---|---|---|---|---|---|
| | | Particle Size Distribution (PSD) μm | | | | | 1 rpm | 5 rpm | 11 rpm | 22 rpm |
| Figure | Protocol | 50% | 90% | 95% | 99% | 100% | Shear1 | shear 5 | shear10 | shear20 |
| 11A | None | 8.9 | 115 | 147.2 | 196.8 | 240 | 10250 | 4940 | 4005 | unreadable |
| | (—) control | | | | | | | | | |
| 11B | B | 6.7 | 87.0 | 112.7 | 151.1 | 186 | 5900 | 2430 | 1795 | 1489 |
| 11C | C | 5.5 | 56.6 | 86.4 | 121 | 162 | 6200 | 2310 | 1632 | 1300 |
| 11D | D | 6.17 | 42.6 | 57.1 | 76.6 | 97.9 | 6100 | 2300 | 1320 | 1295 |

In some exemplary embodiments of the invention there is provided a whole grain crude tahini composition having at least 13% crude fiber in a proximate analysis and characterized by a Particle Size Distribution (PSD) of 90% of less than 115 μm as measured by laser diffraction using a Malvern—Mastersizer 3000 Wet dispersion with Hydro EV cell with ISOPAR G as dispersant. According to various exemplary embodiments of the invention the whole grain crude tahini composition having at least 13% crude fiber in a proximate analysis is characterized by a Particle Size Distribution (PSD) of 90% of less than 80 μm, less than 70 μm, less than 60 μm, less than 50 μm, less than 43 μm, or intermediate or smaller sizes.

Alternatively or additionally, in some embodiments this whole grain crude tahini composition is characterized by a Particle Size Distribution (PSD) of 50% of less than 8.9 μm as measured by laser diffraction. According to various exemplary embodiments of the invention this whole grain crude tahini composition is characterized by a Particle Size Distribution (PSD) of 50% of less than 6 μm, less than 5.5 μm.

Alternatively or additionally, according to various exemplary embodiments of the invention this whole grain crude tahini composition is characterized by a viscosity cP SC4-21 at 11 RPM of less than 4000, less than 3000, less than 2500, less than 2000, less than 1795, less than 1700, less than 1600, less than 1500, less than 1400, less than 1320 or intermediate or lower viscosities.

Alternatively or additionally, in some embodiments this whole grain crude tahini composition is characterized by a viscosity cP SC4-21 at 5 RPM of less than 4900, less than 4000, less than 3500, less than 3000, less than 2500, less than 2430, less than 2300, or intermediate or lower viscosities.

### Exemplary Microfluidization of Olives

Pitted sliced green olives were alkaline processed (NaOH) then cured in 6% brine for three weeks then soaked in water 4 times (2 hours per time) to remove salt. The sliced olives were then dried at 55° C. for 10 hours with a fan at high speed to dry them. Dry matter yield was 13-15%. This material was ground in a 500 micron grinder prior to microfluidization.

The resultant product was microfluidized according to protocol C in Table 5A.

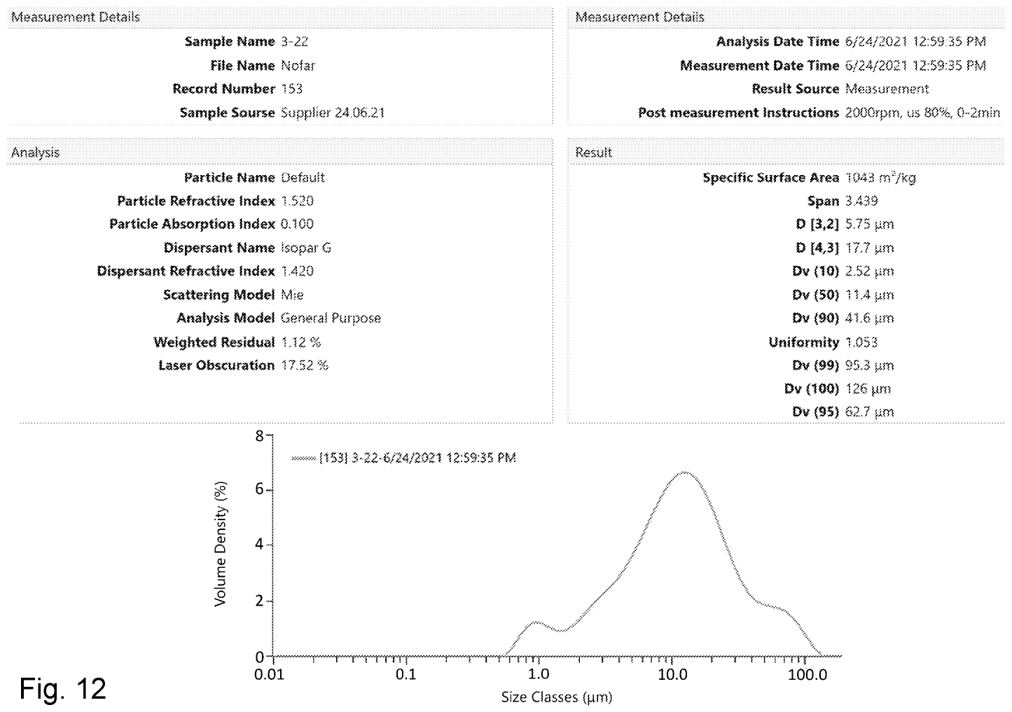

The microfluidized liquefied whole olive product was analyzed for PSD and viscosity. PSD results are presented graphically in FIG. 12 and summarized numerically in Table 6, together with corresponding viscosity data.

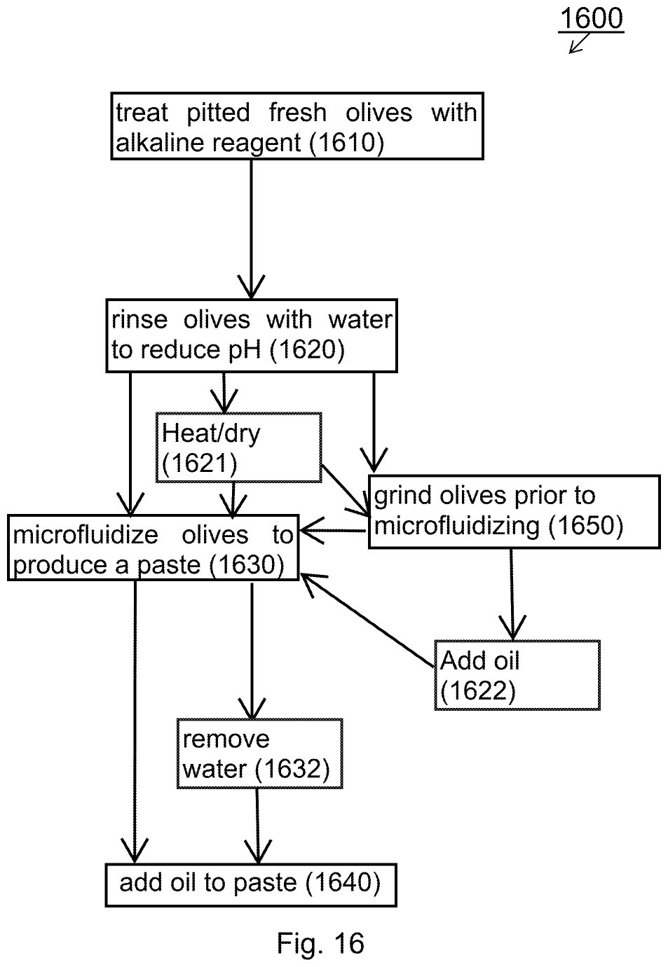

FIG. 16 is a simplified flow diagram of a method for producing an olive product, indicated generally as 1600 according to some exemplary embodiment's of the invention. Depicted exemplary method 1600 includes treating 1610 pitted fresh olives with an alkaline reagent (e.g. a hydroxide solution) rinsing 1620 the olives with water to reduce the pH. In some exemplary embodiments of the invention, the rinsing reduces the pH to 6 to 8. Alternatively or additionally, in some embodiments the olives are heated 1621. In some exemplary embodiments of the invention, heating 1621 dries the olives. In some embodiments, the olives are pre-ground 1650 at this stage. In some embodiments, oil is added 1622 to the pre-ground olives before, during or after grinding 1650. At 1630, the olives are microfluidized to produce a paste. In some exemplary embodiments of the invention, oil is added 1640 to the paste. In some embodiments, addition of oil contributes to a desired viscosity of the final product. Alternatively or additionally, in some embodiments the method includes removing water 1632 from paste 1630. According to various exemplary embodiments of the invention water removal is by heating and/or centrifugation. According to various exemplary embodiments of the invention the final product has a consistency between oil and balsamic vinegar.

Alternatively or additionally, in some embodiments the method includes spray drying or freeze drying the paste (not depicted).

TABLE 6
PSD of liquefied whole olive product after Microfluidization according to the
protocol presented above using Isopar G as a dispersant and corresponding
Viscosity CP SC4-21 (cP) data.
Microfluidized real olive

| | | | | | Viscosity CP SC4-21 (cP) | | | | | |
|---|---|---|---|---|---|---|---|---|---|---|
| Particle Sized Distribution (PSD) μm | | | | | 1 rpm | 5 rpm | 11 rpm | 22 rpm | 50 rpm | 100 rpm |
| 50% | 90% | 95% | 99% | 100% | Shear 1 | Shear 5 | Shear 10 | Shear 20 | Shear 46 | Shear 93 |
| 11.4 | 41.6 | 62.7 | 95.3 | 126 | 950 | 490 | 400 | 350 | 316 | 301 |

This experiment demonstrates the possibility of producing a liquefied whole olive product without pit fragments. The resultant microfluidized product is dark in color and evocative of balsamic vinegar. The product is delicious on vegetables and the flavor and aroma are characteristic of olives. This product retains the fiber, protein, and antioxidants of whole olives.

In other exemplary embodiments of the invention, olive press pomace is used as an input for the method. According to these embodiments, seed fragments are removed from the pomace. Seed fragments can be removed from pomace, for example, by using a colloid mill.

Colloid mills suitable for this purpose are available commercially, for example from OFM Food Machinery (Sevilla, Spain; www.ofmsl.com)

In some exemplary embodiments of the invention, drying of the pomace contributes to a reduction in bitterness. In some exemplary embodiments of the invention, drying is to about 12% to 32% dry matter by weight.

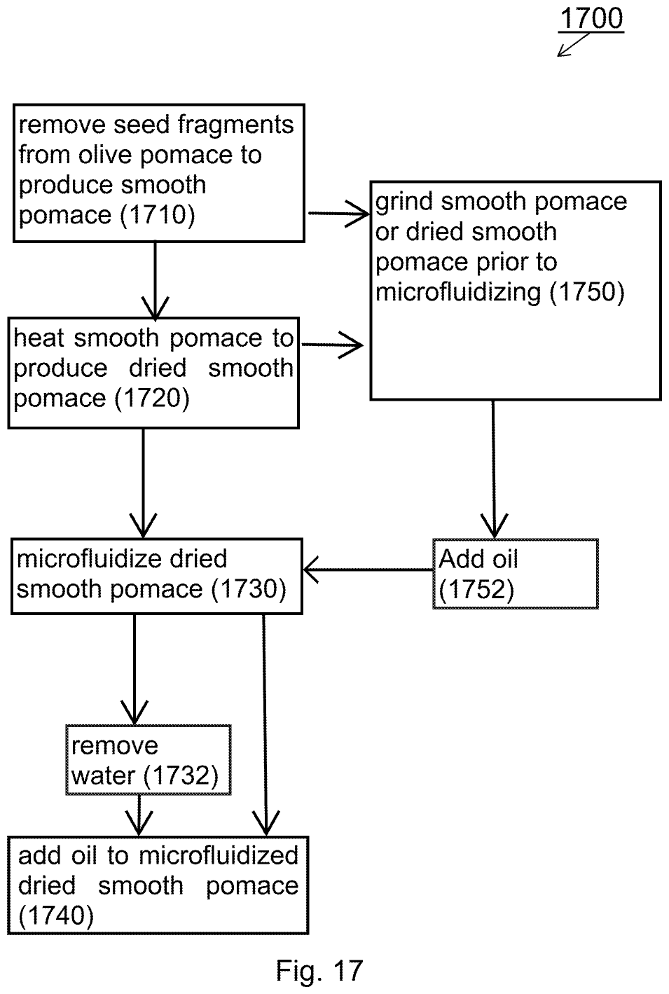

FIG. 17 is a simplified flow diagram of a method for producing an olive product, indicated generally as 1700 according to some exemplary embodiment's of the invention. Depicted exemplary method 1700 includes removing 1710 seed fragments from olive pomace to produce smooth pomace and heating 1720 the smooth pomace to produce regular pomace with less flavor and better taste or dried smooth pomace. In the depicted embodiment, the dried smooth pomace is then microfluidized 1730. In some exemplary embodiments of the invention, method 1700 includes adding 1740 oil to the microfluidized dried smooth pomace. In some exemplary embodiments of the invention, method 1700 includes grinding 1750 the smooth pomace or the dried smooth pomace prior to microfluidizing. In some embodiments, oil is added 1752 before during or after grinding 1750. Alternatively or additionally, in some embodiments the method includes removing water 1732 from dried smooth pomace 1730. According to various exemplary embodiments of the invention water removal is by heating and/or centrifugation.

### Exemplary Microfluidized Olive Product

In some exemplary embodiments of the invention there is provided a processed olive composition characterized by a Particle Size Distribution (PSD) of 90% of less than 41.6 μm as measured by laser diffraction using a Malvern—Mastersizer 3000 Wet dispersion with Hydro EV cell with Isopar G as dispersant. Alternatively or additionally, in some embodiments there is provided a processed olive composition characterized by a Particle Size Distribution (PSD) of 50% of less than 11.4 μm as measured by laser diffraction using a Malvern—Mastersizer 3000 Wet dispersion with Hydro EV cell with Isopar G as dispersant. Alternatively or additionally, in some embodiments the processed olive composition is characterized by a viscosity cP SC4-21 at 5 RPM of 490 or less. Alternatively or additionally, in some embodiments the processed olive composition is characterized by a viscosity cP SC4-21 at 11 RPM of 400 or less.

### Protocol for Particle Size Distribution Analysis by Laser Diffraction

Particle Size Distribution (PSD) was analyzed by laser diffraction using a Malvern—Mastersizer 3000 Wet dispersion with Hydro EV cell. Either water or Isopar G served as dispersant as indicated. PSD is expressed as a series of percentages. Each percentage indicates what proportion of particles are below the indicated size (in urn). For example, 99% μm of 49.9 indicates that 99% of particles are 49.9 μm or less.

Operational Parameters of the 42-Nasus-isopar were set as follows: Optical model: Default, particles RI=1.52, particles absorption index=0.1, Isopar G RI=1.42

Measurement: 3 measurements of 10 seconds

Pump/stirrer speed=2000 rpm

Obscuration level range—2-12 percent.

Samples were prepared by rolling the container gently for 30 seconds.

For the laser diffraction measurement, the Hydro EV cell was filled with 350 cc of the carrier. Pump speed was set to 2000 RPM and the pump was activated.

A manual measurement window was opened and requested optical model, and the sample name, source and type, bulk lot reference, and operator notes were entered. Alignment of the laser was conducted and the background was measured.

Mixed sample was added into the measuring cell, filled with blank until the obscuration is in the range specified in the obscuration window.

A waiting time of 20-30 seconds allowed sample dispersion.

The “start” button was pressed for the first measurement. Measurements were repeated after 1 and 3 min. At the end of the measurement, the measurement window was closed, the best result was selected and the report was printed.

Unless otherwise indicated, all reference to “laser diffraction” in this specification and the accompanying claims refer to this protocol. Unless otherwise indicated all measurements of particle size distribution (PSD) in this specification and the accompanying claims refer to this protocol.

### Protocol for Viscosity Measurement

All viscosity measurements were performed using a BROOKFIELD viscometer RV DV-PRO WXTRA at the indicated number of RPMs. Results are expressed as cP SC4-21 (cP).

1. All tests were conducted at room temperature.

2. The sample container was provided with the viscometer as a kit and has a depth of about 60 mm and an internal diameter of about 18 mm. Internal volume is about 24 ml. After insertion of the weight, sample volume is about ˜7.5 ml.

3. The liquid tahini was added in sufficient volume to cover to top of the cylinder.

4. The viscometer model was DV-II+Pro EXTRA RV

5. The spindle was type SC4-21

6. The number of RPM is as indicated in tables 1 and 2 hereinabove.

7. The amount of time needed before viscosity was recorded was selected automatically by the viscometer.

8. Samples were prepared by mixing with a high shear mixer to homogeneity.

Claimed viscosity values result from implementation of this protocol.

### Exemplary Spray Drying Equipment

Spray drying is a common procedure in the food industry and a wide variety of spray drying equipment is commercially available. One spray drying machine suitable for use in the context of various exemplary embodiments of the invention is the NIRO Atomizer (NIRO; Copenhagen Denmark). In general, spray dryers include a rotating atomizer which produces drops. These drops dry as they fall. A higher height for the atomizer contributes to increased drying capacity and/or decreased entrance temperature and/or decreased exit temperature. Alternatively or additionally, an increase in temperature of drops exiting above the atomizer contributes to increased drying efficiency. According to various exemplary embodiments of the invention the temperature of air entering above the atomizer is 200° C., 160° C., 130° C., 100° C. 90° C., 80° C., 70° C., 60° C. or intermediate or lower temperatures. Alternatively or additionally, in some embodiments the entrance temperature of the dryer is 130° C., 140° C., 150° C., 160° C., or intermediate or lower temperatures.

In some exemplary embodiments of the invention, a vacuum spray dryer as described in U.S. Pat. No. 8,966,783 (fully incorporated herein by reference) is employed. Dryers of this type are available from Tanabe Engineering Corporation, Japan. In other exemplary embodiments of the invention, other types of vacuum spray dryers are employed.

In some exemplary embodiments of the invention, a vacuum spray dryer or drum dryer with an operating temperature of 70° C., 60° C., 55° C. or intermediate or lower temperatures contributes to an improvement in rheology characteristics of the spray dried material or products which contain them.

Exemplary spray drying protocol In some exemplary embodiments of the invention, crude tahini is mixed with water to produce a prepared tahini emulsion and dried in a spray dryer.

In some embodiments, prepared tahini emulsion is microfluidized at a pressure of at least 5000 PSI and then dried in a spray dryer.

In some embodiments, crude tahini is microfluidized at a pressure of at least 5000 PSI and then mixed with water to produce a prepared tahini emulsion and dried in a spray dryer. In some exemplary embodiments of the invention, the prepared tahini emulsion is microfluidized at a pressure of at least 5000 PSI prior to the spray drying.

In some exemplary embodiments of the invention, rice bran extract is added to the water at up to 12% by weight of the crude tahini and the solution is mixed. In some exemplary embodiments of the invention, the mixing is under heating. In some embodiments, the heating includes until boiling for several minutes. In some embodiments, the heated solution is then cooled.

In some exemplary embodiments of the invention, the resultant solution of rice bran extract in water is used instead of water in the spray drying protocols above. In some exemplary embodiments of the invention, the resultant solution of rice bran extract in water is microfluidized with mixing with tahini or without mixing with tahini before drying.

In some exemplary embodiments of the innovation, the result solution of rice bran extract in water is microfluidized.

In some exemplary embodiments of the invention, the mixture of tahini and water (with or without rice bran extract) is cooled to aid in formation and/or stabilization of an emulsion.

### Exemplary Rice Bbran Extract

In some embodiments, rice bran extract (RBE) is added to prepared tahini or other finely ground oily seed suspensions containing water prior to spray drying. One example of rice bran extract suitable for use in various exemplary embodiments of the invention is Nu-RICE/Nu-BAKE from RIBUS INC. (St. Louis; Mo., USA).

### Exemplary Oily Seed Types

Microfluidization to produce homogenates and/or spray drying of the homogenates are expected to be applicable to a variety of oily seeds including, but not limited to, white sesame, red sesame, black sesame, nigella, peanuts, pistachios, almonds, Brazil nuts, macadamia nuts, hazelnuts, pecans, cashews, olives (with pits removed), sunflower seeds, corn kernels, wheat kernels, and soybeans.

According to various exemplary embodiments of the invention, these seeds are ground using only their natural oil and/or with their natural oil plus oil from another source and/or using only oil from another source (i.e. after their natural oil is extracted).

### Exemplary use Scenarios

Spray-dried powder produced from homogenates of sesame seeds and/or other oily seeds is expected to find utility as a substitute for powdered milk and/or powdered eggs in a wide variety of commercial food products including, but not limited to, chocolate, cookies, candy, bread, ground meat and pasta.

Chocolate tablets and chocolate commonly include spray-dried milk powder as an ingredient. Any substitute for spray-dried milk powder should have a similar PSD (i.e. 90% <30 μm). Further decreases in particle size contribute to increased smoothness of the resultant chocolate. The PSD of spray-dried tahini suggests it is an acceptable substitute for milk powder in the preparation of chocolate (See Table 3 above). In some embodiments of the invention, chocolate is manufactured using spray-dried tahini as a substitute for powdered milk.

Alternatively or additionally, in some embodiments, spray-dried tahini is mixed with sugar(s) and/or flavorings (e.g. vanilla, cacao, nuts) to produce halva.

Alternatively or additionally, in some embodiments spray-dried tahini serves as a substitute for powdered milk in chocolate spread. Alternatively or additionally, in some embodiments, spray-dried tahini is added to nut butters (e.g. peanut butter, almond butter, chestnut paste).

Alternatively or additionally, according to various exemplary embodiments of the invention spray-dried tahini powder serves as an ingredient in prepared sport nutrition, cake frosting and/or powdered soup mix and/or seasoning mixes and/or powdered salad dressings and/or prepared salads and/or Hummus by adding Hummus powder and lemon, salt and spices and/or mayonnaise and/or mayonnaise substitutes.

Comparison to Previously Available Alternatives While there are spray dried products derived from nuts and oily seeds in the marketplace, these previously available alternatives contain only about 50% nuts/seeds. The remainder of the product is bulking agent(s) such as maltodextrin.

In sharp contrast maltodextrin and/or other bulking agents are not required in powdered products derived from nuts and oily seeds according to exemplary embodiments of the invention.

### Exemplary Health Considerations

Microfluidization 110 (FIG. 1A) is known to disrupt bacterial cell walls and/or cell membranes, inactivating the bacteria. As a result, microfluidization of tahini (or comparable products prepared from other oily seeds or nuts) obviates a need for pasteurization or other heat treatments. Obviation of the need for pasteurization or other heat treatment contributes to the simplification of industrial-scale processes.

### Microfluidization of Crude Tahini Influences Emulsion Stability in Prepared Tahini

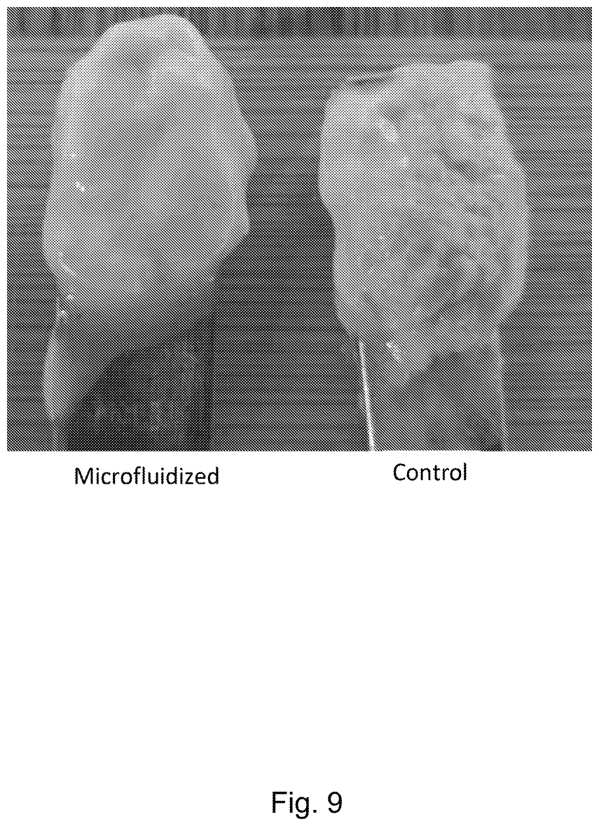

FIG. 9 is a photograph of samples of prepared tahini made from microfluidized crude tahini according to an exemplary embodiment of the invention and prepared tahini made from control crude tahini after heating.

Briefly 6.5 grams of microfluidized crude tahini and 6.5 grams of control crude tahini were each mixed with 4.5 grams of water to produce prepared tahini.

The two prepared tahinis were each placed in a 90° C. water bath for 4 minutes.

Samples were taken with a metal spatula, placed side by side and photographed.

FIG. 9 clearly shows that the emulsion of the prepared tahini produced from microfluidized crude tahini remained intact after heating while the emulsion of the prepared tahini produced from control crude tahini broke down.

### Exemplary Reduced Fat Crude Tahini

In some exemplary embodiments of the invention, the change in PSD caused by microfluidization and/or the resultant reduction in viscosity contribute to an ability to remove oil from the crude tahini to produce a reduced fat crude tahini. According to various exemplary embodiments of the invention the reduced fat crude tahini has 10%, 20%, 30% or 35% or intermediate or greater percentages less fat/oil than the crude tahini from which it is prepared. In some embodiments the reduced fat crude tahini remains liquid and can be used just like conventional (full fat/oil) crude tahini. In some exemplary embodiments of the invention, the reduced fat/oil crude tahini has sufficiently low viscosity to be amenable to use in a squeeze bottle.

This is in contrast to conventional crude tahini where oil removal contributes to a dramatic increase in viscosity which makes the reduced fat product virtually unusable.

Exemplary fat reduction methods include, but are not limited to:
(A) Pressing of roasted sesame seeds to remove the desired amount of oil followed by conventional grinding (ball mill and/or millstones/Macintyre/Reifiner Conche) followed by microfluidization according to an exemplary embodiment of the invention.
(B) Removal of the desired amount of oil from microfluidized crude tahini according to an exemplary embodiment of the invention by centrifugation and/or microfiltration.

The same strategy can be employed to prepare reduced fat/oil versions of other oily seed pastes (e.g. peanut butter or almond butter).

In some exemplary embodiments of the invention there is provided a method including: (a) microfluidizing crude tahini to produce microfluidized crude tahini; and (b) removing oil from the microfluidized crude tahini. In some embodiments, removing oil includes centrifuging the microfluidized crude tahini. Alternatively or additionally, in some embodiments the removing oil removes at least 10% of the oil.

In some exemplary embodiments of the invention there is provided a reduced fat/oil microfluidized crude tahini composition having a viscosity cP SC4-21 at 11 RPM of 2296 or less. Alternatively or additionally, in some exemplary embodiments of the invention there is provided a reduced fat microfluidized crude tahini composition having a viscosity cP SC4-21 at 5 RPM of 2756 or less.

It is expected that during the life of this patent many grinding and milling machines will be developed and the scope of the invention is intended to include all such new technologies a priori.

As used herein the term “about” refers to ±10%. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of tahini but might also be used in the context of peanut butter, almond butter or other nut butters or bean pastes (e.g. humus, black bean paste or refried beans.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

### SOURCE DATA FOR PARTICLE SIZE DISTRIBUTION PLOTS

| Source data for | | Source date for | | Source data for | |
|---|---|---|---|---|---|
| FIG. 1B | | FIG. 1C | | FIG. 2A | |
| Size (μm) | % Volume Under | Size (μm) | % Volume Under | % Volume Under | Size (μm) |
| 0.523 | 0 | 0.523 | 0 | 0 | 0.523 |
| 0.594 | 0.43 | 0.594 | 0.25 | 0.11 | 0.594 |
| 0.675 | 1.53 | 0.675 | 1.15 | 0.6 | 0.675 |
| 0.767 | 3.3 | 0.767 | 2.88 | 1.62 | 0.767 |
| 0.872 | 3.48 | 0.872 | 5.25 | 3.08 | 0.872 |
| 0.991 | 7.75 | 0.991 | 7.87 | 4.75 | 0.991 |
| 1.13 | 9.84 | 1.13 | 10.37 | 6.4 | 1.13 |
| 1.28 | 11.7 | 1.28 | 12.62 | 7.94 | 1.28 |
| 1.45 | 13.43 | 1.45 | 14.59 | 9.4 | 1.45 |
| 1.65 | 15.24 | 1.65 | 16.85 | 10.92 | 1.65 |
| 1.88 | 17.3 | 1.88 | 19.33 | 12.62 | 1.88 |
| 2.13 | 19.68 | 2.13 | 22.3 | 14.59 | 2.13 |
| 2.42 | 22.42 | 2.42 | 25.84 | 16.84 | 2.42 |
| 2.75 | 25.45 | 2.75 | 29.89 | 19.39 | 2.75 |
| 3.12 | 28.72 | 3.12 | 34.33 | 22.21 | 3.12 |
| 3.55 | 32.16 | 3.55 | 39.04 | 25.33 | 3.55 |
| 4.03 | 35.74 | 4.03 | 43.9 | 28.73 | 4.03 |
| 4.58 | 39.41 | 4.38 | 48.86 | 32.41 | 4.58 |
| 5.21 | 43.13 | 5.21 | 53.82 | 36.3 | 5.21 |
| 5.92 | 46.82 | 5.92 | 58.72 | 40.29 | 5.92 |
| 6.72 | 50.41 | 6.72 | 63.46 | 44.23 | 6.72 |
| 7.64 | 53.81 | 7.64 | 67.95 | 47.98 | 7.64 |
| 8.68 | 56.94 | 8.68 | 72.09 | 51.38 | 8.68 |
| 9.86 | 59.73 | 9.86 | 75.8 | 54.35 | 9.86 |
| 11.2 | 62.16 | 11.2 | 79.02 | 56.85 | 11.2 |
| 12.7 | 64.26 | 12.7 | 81.76 | 58.93 | 12.7 |
| 14.5 | 66.06 | 14.5 | 84.03 | 60.68 | 14.5 |
| 16.4 | 67.67 | 16.4 | 85.92 | 62.23 | 16.4 |
| 18.7 | 69.15 | 18.7 | 87.52 | 63.71 | 18.7 |
| 21.2 | 70.59 | 21.2 | 88.94 | 65.23 | 21.2 |
| 24.1 | 72.03 | 24.1 | 90.28 | 66.85 | 24.1 |
| 27.4 | 73.48 | 27.4 | 91.64 | 68.59 | 27.4 |
| 31.1 | 74.93 | 31.1 | 93.05 | 70.43 | 31.1 |
| 35.3 | 76.35 | 35.3 | 94.52 | 72.34 | 35.3 |
| 40.1 | 77.72 | 40.1 | 95.98 | 74.25 | 40.1 |
| 45.6 | 79.02 | 45.6 | 97.36 | 76.15 | 45.6 |
| 51.6 | 80.26 | 51.8 | 98.51 | 78.02 | 51.8 |
| 58.9 | 81.51 | 58.9 | 99.35 | 79.88 | 58.9 |
| 66.9 | 82.84 | 66.9 | 99.83 | 81.78 | 66.9 |
| 76 | 84.34 | 76 | 100 | 83.78 | 76 |
| 86.4 | 86.11 | | | 85.93 | 86.4 |
| 98.1 | 88.17 | | | 88.26 | 98.1 |
| 111 | 90.51 | | | 90.73 | 111 |
| 127 | 92.98 | | | 93.21 | 127 |
| 144 | 95.36 | | | 95.53 | 144 |
| 163 | 97.41 | | | 97.48 | 163 |
| 186 | 98.91 | | | 99.91 | 186 |
| 211 | 99.77 | | | 99.75 | 211 |
| 240 | 100 | | | 100 | 240 |

| Source data for | | Source data for | | | |
|---|---|---|---|---|---|
| FIG. 2B | | FIG. 3A | | | |
| % Volume Under | Size (μm) | % Volume Under | Size (μm) | % Volume Under | Size (μm) |
| 0 | 0.523 | 0 | 0.523 | 98.11 | 211 |
| 0.16 | 0.594 | 0.38 | 0.594 | 98.8 | 240 |
| 0.82 | 0.675 | 1.39 | 0.675 | 99.31 | 272 |
| 2.16 | 0.767 | 3.08 | 0.767 | 99.67 | 310 |
| 4.06 | 0.872 | 5.22 | 0.872 | 99.89 | 352 |
| 6.22 | 0.991 | 7.54 | 0.991 | 100 | 400 |
| 8.35 | 1.13 | 9.8 | 1.13 | | |
| 10.33 | 1.28 | 11.99 | 1.28 | | |
| 12.22 | 1.45 | 14.2 | 1.45 | | |
| 14.21 | 1.65 | 16.57 | 1.65 | | |
| 16.47 | 1.88 | 19.2 | 1.88 | | |
| 19.11 | 2.13 | 22.11 | 2.13 | | |
| 22.15 | 2.42 | 25.24 | 2.42 | | |
| 25.58 | 2.75 | 28.49 | 2.75 | | |
| 29.35 | 3.12 | 31.81 | 3.12 | | |
| 33.43 | 3.55 | 35.15 | 3.55 | | |
| 37.76 | 4.03 | 38.53 | 4.03 | | |
| 42.29 | 4.58 | 41.98 | 4.58 | | |
| 46.96 | 5.21 | 45.52 | 5.21 | | |
| 51.62 | 5.92 | 49.15 | 5.92 | | |
| 56.17 | 6.72 | 52.84 | 6.72 | | |
| 60.47 | 7.64 | 56.51 | 7.64 | | |
| 64.42 | 8.68 | 60.09 | 8.68 | | |
| 67.92 | 9.86 | 63.49 | 9.86 | | |
| 70.99 | 11.2 | 66.65 | 11.2 | | |
| 73.65 | 12.7 | 69.52 | 12.7 | | |
| 75.94 | 14.5 | 72.11 | 14.5 | | |
| 77.96 | 16.4 | 74.42 | 16.4 | | |
| 79.78 | 18.7 | 76.5 | 18.7 | | |
| 81.47 | 21.2 | 78.39 | 21.2 | | |
| 83.1 | 24.1 | 80.11 | 24.1 | | |
| 84.72 | 27.4 | 81.68 | 27.4 | | |
| 86.39 | 31.1 | 83.11 | 31.1 | | |
| 88.17 | 35.3 | 84.4 | 35.3 | | |
| 90.09 | 40.1 | 85.56 | 40.1 | | |
| 92.13 | 45.6 | 86.61 | 45.6 | | |
| 94.21 | 51.8 | 87.56 | 51.8 | | |
| 96.19 | 58.9 | 88.45 | 58.9 | | |
| 97.88 | 66.9 | 89.3 | 66.9 | | |
| 99.12 | 76 | 90.16 | 76 | | |
| 99.82 | 86.4 | 91.06 | 86.4 | | |
| 100 | 98.1 | 92.03 | 98.1 | | |
| | | 93.06 | 111 | | |
| | | 94.15 | 127 | | |
| | | 95.24 | 144 | | |
| | | 96.3 | 163 | | |
| | | 97.27 | 186 | | |
| Source data for | | Source data for | | | |
| FIG. 3B | | FIG. 4A | | | |
| % Volume Under | Size (μm) | % Volume Under | Size (μm) | % Volume Under | Size (μm) |
| 0 | 0.523 | 0 | 0.523 | 84.94 | 211 |
| 0.47 | 0.594 | 0.26 | 0.594 | 86.52 | 240 |
| 1.73 | 0.675 | 1 | 0.675 | 88.13 | 272 |
| 3.81 | 0.767 | 2.27 | 0.767 | 89.77 | 310 |
| 6.45 | 0.872 | 3.93 | 0.872 | 91.41 | 352 |
| 9.31 | 0.991 | 5.77 | 0.991 | 93.02 | 400 |
| 12.13 | 1.13 | 7.61 | 1.13 | 94.55 | 454 |
| 14.87 | 1.28 | 9.4 | 1.28 | 95.98 | 516 |
| 17.66 | 1.45 | 11.22 | 1.45 | 97.24 | 586 |
| 20.66 | 1.65 | 13.15 | 1.65 | 98.29 | 666 |
| 24.01 | 1.88 | 15.27 | 1.88 | 99.08 | 756 |
| 27.72 | 2.13 | 17.57 | 2.13 | 99.62 | 859 |
| 31.71 | 2.42 | 20.01 | 2.42 | 99.93 | 976 |
| 35.84 | 2.75 | 22.53 | 2.75 | 100 | 1110 |
| 40 | 3.12 | 25.1 | 3.12 | | |
| 44.11 | 3.55 | 27.71 | 3.55 | | |
| 48.16 | 4.03 | 30.38 | 4.03 | | |
| 52.15 | 4.58 | 33.15 | 4.58 | | |
| 56.12 | 5.21 | 36.03 | 5.21 | | |
| 60.07 | 5.92 | 39.01 | 5.92 | | |
| 63.97 | 6.72 | 42.05 | 6.72 | | |
| 67.77 | 7.64 | 45.08 | 7.64 | | |
| 71.41 | 8.68 | 48.02 | 8.58 | | |
| 74.79 | 9.86 | 50.79 | 9.86 | | |
| 77.86 | 11.2 | 53.32 | 11.2 | | |
| 80.58 | 12.7 | 55.59 | 12.7 | | |
| 82.95 | 14.5 | 57.59 | 14.5 | | |
| 85 | 16.4 | 59.35 | 16.4 | | |
| 86.78 | 18.7 | 60.92 | 18.7 | | |
| 88.35 | 21.2 | 62.34 | 21.2 | | |
| 89.76 | 24.1 | 63.65 | 24.1 | | |
| 91.04 | 27.4 | 64.9 | 27.4 | | |
| 92.25 | 31.1 | 66.1 | 31.1 | | |
| 93.4 | 35.3 | 67.28 | 35.3 | | |
| 94.5 | 40.1 | 68.46 | 40.1 | | |
| 95.55 | 45.6 | 69.63 | 45.6 | | |
| 96.55 | 51.8 | 70.8 | 51.8 | | |
| 97.45 | 58.9 | 71.98 | 58.9 | | |
| 98.24 | 66.9 | 73.16 | 66.9 | | |
| 98.88 | 76 | 74.35 | 76 | | |
| 99.36 | 86.4 | 75.54 | 86.4 | | |
| 99.7 | 98.1 | 76.76 | 98.1 | | |
| 99.9 | 111 | 78 | 111 | | |
| 100 | 127 | 79.28 | 127 | | |
| | | 80.6 | 144 | | |
| | | 81.98 | 163 | | |
| | | 83.43 | 186 | | |
| Source data for | | Source data for | | | |
| FIG. 4B | | FIG. 5A | | | |
| % Volume Under | Size (μm) | % Volume Under | Size (μm) | % Volume Under | Size (μm) |
| 0 | 0.523 | 0 | 0.523 | 97.9 | 211 |
| 0.44 | 0.594 | 0.39 | 0.594 | 98.36 | 240 |
| 1.57 | 0.675 | 1.3 | 0.675 | 98.76 | 272 |
| 3.43 | 0.797 | 2.72 | 0.767 | 99.1 | 310 |
| 5.79 | 0.872 | 4.46 | 0.872 | 99.37 | 352 |
| 8.34 | 0.991 | 6.25 | 0.991 | 99.6 | 400 |
| 10.84 | 1.13 | 7.92 | 1.13 | 99.78 | 454 |
| 13.26 | 1.28 | 9.43 | 1.28 | 99.91 | 516 |
| 15.68 | 1.45 | 10.88 | 1.45 | 100 | 586 |
| 18.25 | 1.65 | 12.39 | 1.65 | | |
| 21.06 | 1.88 | 14.03 | 1.88 | | |
| 24.13 | 2.13 | 15.82 | 2.13 | | |
| 27.39 | 2.42 | 17.71 | 2.42 | | |
| 30.76 | 2.75 | 19.61 | 2.75 | | |
| 34.18 | 3.12 | 21.42 | 3.12 | | |
| 37.64 | 3.55 | 23.1 | 3.55 | | |
| 41.16 | 4.03 | 24.62 | 4.03 | | |
| 44.77 | 4.58 | 26.03 | 4.58 | | |
| 48.5 | 5.21 | 27.35 | 5.21 | | |
| 52.33 | 5.92 | 28.64 | 5.92 | | |
| 56.22 | 6.72 | 29.95 | 6.72 | | |
| 60.09 | 7.64 | 31.32 | 7.64 | | |
| 63.84 | 8.68 | 32.79 | 8.68 | | |
| 67.4 | 9.86 | 34.41 | 9.86 | | |
| 70.69 | 11.2 | 36.21 | 11.2 | | |
| 73.69 | 12.7 | 38.25 | 12.7 | | |
| 76.38 | 14.5 | 40.58 | 14.5 | | |
| 78.81 | 16.4 | 43.26 | 16.4 | | |
| 80.98 | 18.7 | 46.32 | 18.7 | | |
| 82.94 | 21.2 | 49.78 | 21.2 | | |
| 84.7 | 24.1 | 53.63 | 24.1 | | |
| 86.27 | 27.4 | 57.82 | 27.4 | | |
| 87.67 | 31.1 | 62.26 | 31.1 | | |
| 88.94 | 35.3 | 66.85 | 35.3 | | |
| 90.12 | 40.1 | 71.44 | 40.1 | | |
| 91.25 | 45.6 | 75.88 | 45.6 | | |
| 92.39 | 51.8 | 80.01 | 51.8 | | |
| 93.56 | 58.9 | 83.72 | 58.9 | | |
| 94.76 | 66.9 | 86.9 | 66.9 | | |
| 95.96 | 76 | 89.52 | 76 | | |
| 97.11 | 86.4 | 91.59 | 86.4 | | |
| 98.13 | 98.1 | 93.19 | 98.1 | | |
| 98.96 | 111 | 94.41 | 111 | | |
| 99.54 | 127 | 95.37 | 127 | | |
| 99.87 | 144 | 96.14 | 144 | | |
| 100 | 163 | 96.8 | 163 | | |
| | | 97.38 | 186 | | |

Source data for
FIG. 5B

| % Volume Under | Size (μm) | % Volume Under | Size (μm) |
|---|---|---|---|
| 0 | 0.46 | 99.59 | 186 |
| 0.08 | 0.523 | 99.86 | 211 |
| 0.52 | 0.594 | 100 | 240 |
| 1.51 | 0.675 | | |
| 3.02 | 0.767 | | |
| 4.84 | 0.872 | | |
| 6.71 | 0.991 | | |
| 8.46 | 1.13 | | |
| 10.05 | 1.28 | | |
| 11.56 | 1.45 | | |
| 13.11 | 1.65 | | |
| 14.79 | 1.88 | | |
| 16.59 | 2.13 | | |
| 18.47 | 2.42 | | |
| 20.34 | 2.75 | | |
| 22.11 | 3.12 | | |
| 23.73 | 3.55 | | |
| 25.2 | 4.03 | | |
| 26.56 | 4.58 | | |
| 27.84 | 5.21 | | |
| 29.09 | 5.92 | | |
| 30.38 | 6.72 | | |
| 31.74 | 7.64 | | |
| 33.21 | 8.68 | | |
| 34.84 | 9.86 | | |
| 36.66 | 11.2 | | |
| 38.74 | 12.7 | | |
| 41.13 | 14.5 | | |
| 43.89 | 16.4 | | |
| 47.05 | 18.7 | | |
| 50.65 | 21.2 | | |
| 54.67 | 24.1 | | |
| 59.05 | 27.4 | | |
| 63.7 | 31.1 | | |
| 68.51 | 35.3 | | |
| 73.31 | 40.1 | | |
| 77.94 | 45.6 | | |
| 82.25 | 51.8 | | |
| 86.1 | 58.9 | | |
| 89.39 | 66.9 | | |
| 92.08 | 76 | | |
| 94.2 | 86.4 | | |
| 95.81 | 98.1 | | |
| 97.03 | 111 | | |
| 97.95 | 127 | | |
| 98.65 | 144 | | |
| 99.19 | 163 | | |

| Source data for | | Source data for | | Source data for | |
|---|---|---|---|---|---|
| FIG. 6 | | FIG. 11A | | FIG. 11B | |
| % Volume Under | Size (μm) | % Volume Under | Size (μm) | % Volume Under | Size (μm) |
| 0 | 0.594 | 0 | 0.594 | 0 | 0.523 |
| 0.22 | 0.675 | 0.32 | 0.675 | 0.18 | 0.594 |
| 0.84 | 0.757 | 1.07 | 0.767 | 0.84 | 0.675 |
| 1.86 | 0.872 | 2.22 | 0.872 | 2.1 | 0.767 |
| 3.17 | 0.991 | 3.58 | 0.991 | 3.84 | 0.872 |
| 4.63 | 1.13 | 4.96 | 1.13 | 5.77 | 0.991 |
| 6.21 | 1.28 | 6.24 | 1.28 | 7.62 | 1.13 |
| 7.97 | 1.45 | 7.46 | 1.45 | 9.29 | 1.28 |
| 10.02 | 1.65 | 8.74 | 1.65 | 10.85 | 1.45 |
| 12.46 | 1.88 | 10.21 | 1.88 | 12.46 | 1.65 |
| 15.33 | 2.13 | 11.99 | 2.13 | 14.3 | 1.88 |
| 18.6 | 2.42 | 14.13 | 2.42 | 16.49 | 2.13 |
| 22.21 | 2.75 | 16.63 | 2.75 | 19.09 | 2.42 |
| 26.12 | 3.12 | 19.48 | 3.12 | 22.09 | 2.75 |
| 30.3 | 3.55 | 22.63 | 3.55 | 25.44 | 3.12 |
| 34.73 | 4.03 | 26.06 | 4.03 | 29.1 | 3.55 |
| 39.42 | 4.58 | 29.74 | 4.58 | 33.02 | 4.03 |
| 44.33 | 5.21 | 33.63 | 5.21 | 37.17 | 4.58 |
| 49.4 | 5.92 | 37.64 | 5.92 | 41.48 | 5.21 |
| 54.54 | 6.72 | 41.68 | 6.72 | 45.85 | 5.92 |
| 59.53 | 7.64 | 45.62 | 7.64 | 50.18 | 6.72 |
| 64.53 | 8.68 | 49.35 | 8.68 | 54.33 | 7.64 |
| 69.12 | 9.86 | 52.78 | 9.86 | 58.2 | 8.68 |
| 73.29 | 11.2 | 55.88 | 11.2 | 61.7 | 9.86 |
| 76.99 | 12.7 | 58.62 | 12.7 | 64.79 | 11.2 |
| 80.21 | 14.5 | 61.05 | 14.5 | 67.48 | 12.7 |
| 83.02 | 18.4 | 63.25 | 16.4 | 69.83 | 14.5 |
| 85.48 | 18.7 | 65.27 | 18.7 | 71.88 | 16.4 |
| 87.71 | 21.2 | 67.2 | 21.2 | 73.72 | 18.7 |
| 89.8 | 24.1 | 69.06 | 24.1 | 75.39 | 21.2 |
| 91.79 | 27.4 | 70.87 | 27.4 | 76.91 | 24.1 |
| 93.7 | 31.1 | 72.59 | 31.1 | 78.27 | 27.4 |
| 95.48 | 35.3 | 74.21 | 35.3 | 79.48 | 31.1 |
| 97.07 | 40.1 | 75.71 | 40.1 | 80.52 | 35.3 |
| 98.36 | 45.6 | 77.09 | 45.6 | 81.44 | 40.1 |
| 99.27 | 51.8 | 78.39 | 51.8 | 82.31 | 45.6 |
| 99.8 | 58.9 | 79.7 | 58.9 | 83.25 | 51.8 |
| 100 | 66.9 | 81.11 | 66.9 | 84.39 | 58.9 |
| | | 82.72 | 76 | 85.85 | 66.9 |
| | | 84.63 | 86.4 | 87.69 | 76 |
| | | 86.87 | 98.1 | 89.88 | 86.4 |
| | | 89.38 | 111 | 92.32 | 98.1 |
| | | 92.04 | 127 | 94.77 | 111 |
| | | 94.61 | 144 | 96.95 | 127 |
| | | 96.86 | 163 | 98.62 | 144 |
| | | 98.55 | 186 | 99.63 | 163 |
| | | 99.6 | 211 | 100 | 186 |
| | | 100 | 240 | | |
| Source data for | | Source data for | | Source data for | |
| FIG. 11C | | FIG. 11D | | FIG. 12 | |
| % Volume Under | Size (μm) | % Volume Under | Size (μm) | % Volume Under | Size (μm) |
| 0 | 0.523 | 0 | 0.523 | 0 | 0.594 |
| 0.25 | 0.594 | 0.07 | 0.594 | 0.28 | 0.675 |
| 1.1 | 0.675 | 0.56 | 0.675 | 0.9 | 0.767 |
| 2.66 | 0.767 | 1.7 | 0.767 | 1.82 | 0.872 |
| 4.76 | 0.872 | 3.42 | 0.872 | 2.87 | 0.991 |
| 7.05 | 0.991 | 5.43 | 0.991 | 3.85 | 1.13 |
| 9.21 | 1.13 | 7.44 | 1.13 | 4.72 | 1.28 |
| 11.13 | 1.28 | 9.3 | 1.28 | 5.47 | 1.45 |
| 12.89 | 1.45 | 11.03 | 1.45 | 6.22 | 1.65 |
| 14.71 | 1.65 | 12.82 | 1.65 | 7.09 | 1.88 |
| 15.79 | 1.88 | 14.83 | 1.88 | 8.18 | 2.13 |
| 19.28 | 2.13 | 17.21 | 2.13 | 9.52 | 2.42 |
| 22.24 | 2.42 | 20 | 2.42 | 11.1 | 2.75 |
| 25.67 | 2.75 | 23.21 | 2.75 | 12.92 | 3.12 |
| 29.51 | 3.12 | 26.79 | 3.12 | 14.94 | 3.55 |
| 33.7 | 3.55 | 30.68 | 3.55 | 17.21 | 4.03 |
| 38.2 | 4.03 | 34.85 | 4.03 | 19.77 | 4.58 |
| 42.95 | 4.58 | 39.35 | 4.58 | 22.68 | 5.21 |
| 47.88 | 5.21 | 43.83 | 5.21 | 26.02 | 5.92 |
| 52.87 | 5.92 | 48.49 | 5.92 | 29.82 | 6.72 |
| 57.8 | 6.72 | 53.13 | 6.72 | 34.1 | 7.64 |
| 62.54 | 7.64 | 57.64 | 7.64 | 38.84 | 8.68 |
| 66.94 | 8.68 | 61.9 | 8.68 | 43.96 | 9.86 |
| 70.92 | 9.86 | 65.83 | 9.86 | 49.38 | 11.2 |
| 74.4 | 11.2 | 69.38 | 11.2 | 54.93 | 12.7 |
| 77.37 | 12.7 | 72.51 | 12.7 | 60.47 | 14.5 |
| 79.85 | 14.5 | 75.33 | 14.5 | 65.82 | 16.4 |
| 81.88 | 16.4 | 77.55 | 16.4 | 70.82 | 18.7 |
| 83.52 | 18.7 | 79.54 | 18.7 | 75.33 | 21.2 |
| 84.83 | 21.2 | 81.25 | 21.2 | 79.28 | 24.1 |
| 85.85 | 24.1 | 82.76 | 24.1 | 82.61 | 27.4 |
| 86.63 | 27.4 | 84.18 | 27.4 | 85.37 | 31.1 |
| 87.22 | 31.1 | 85.63 | 31.1 | 87.64 | 35.3 |
| 87.69 | 35.3 | 87.22 | 35.3 | 89.54 | 40.1 |
| 88.12 | 40.1 | 89.04 | 40.1 | 91.21 | 45.6 |
| 88.63 | 45.6 | 91.1 | 45.6 | 92.76 | 51.8 |
| 88.33 | 51.8 | 93.33 | 51.8 | 94.27 | 58.9 |
| 90.3 | 58.8 | 95.54 | 58.9 | 95.75 | 66.9 |
| 91.61 | 66.9 | 97.49 | 66.9 | 97.12 | 76 |
| 93.21 | 76 | 98.94 | 76 | 98.31 | 86.4 |
| 94.99 | 86.4 | 99.78 | 86.4 | 99.2 | 98.1 |
| 96.75 | 98.1 | 100 | 98.1 | 99.76 | 111 |
| 98.27 | 111 | | | 100 | 127 |
| 99.36 | 127 | | | | |
| 99.93 | 144 | | | | |
| 100 | 163 | | | | |
| Source data for | | Source data for | | Source data for | |
| FIG. 13 | | FIG. 14 | | FIG. 15 | |
| % Volume Under | Size (μm) | % Volume Under | Size (μm) | % Volume Under | Size (μm) |
| 0 | 0.523 | 0 | 0.523 | 0 | 0.523 |
| 0.24 | 0.594 | 0.16 | 0.594 | 0.21 | 0.594 |
| 1.3 | 0.675 | 0.82 | 0.675 | 1.12 | 0.675 |
| 3.43 | 0.767 | 2.13 | 0.767 | 2.94 | 0.767 |
| 6.43 | 0.872 | 3.98 | 0.872 | 5.53 | 0.872 |
| 9.81 | 0.991 | 6.07 | 0.991 | 8.46 | 0.991 |
| 13.06 | 1.13 | 8.13 | 1.13 | 11.34 | 1.13 |
| 15.96 | 1.28 | 10.05 | 1.28 | 13.99 | 1.28 |
| 18.6 | 1.45 | 11.9 | 1.45 | 16.48 | 1.45 |
| 21.28 | 1.65 | 13.9 | 1.65 | 19.08 | 1.65 |
| 24.32 | 1.88 | 16.25 | 1.88 | 22.06 | 1.88 |
| 27.92 | 2.13 | 19.14 | 2.13 | 25.65 | 2.13 |
| 32.17 | 2.42 | 22.61 | 2.42 | 29.99 | 2.42 |
| 36.97 | 2.75 | 26.67 | 2.75 | 35.12 | 2.75 |
| 42.17 | 3.12 | 31.19 | 3.12 | 41.02 | 3.12 |
| 47.6 | 3.55 | 36.07 | 3.55 | 47.65 | 3.55 |
| 53.12 | 4.03 | 41.18 | 4.03 | 54.97 | 4.03 |
| 58.63 | 4.58 | 46.43 | 4.58 | 62.85 | 4.58 |
| 64.1 | 5.21 | 51.7 | 5.21 | 71.03 | 5.21 |
| 69.46 | 5.92 | 56.87 | 5.92 | 79.07 | 5.92 |
| 74.7 | 6.72 | 61.82 | 6.72 | 86.41 | 6.72 |
| 79.74 | 7.64 | 66.43 | 7.64 | 92.45 | 7.64 |
| 84.51 | 8.68 | 70.6 | 8.68 | 96.74 | 8.58 |
| 88.88 | 9.86 | 74.25 | 9.86 | 99.14 | 9.86 |
| 92.69 | 11.2 | 77.36 | 11.2 | 100 | 11.2 |
| 95.77 | 12.7 | 79.94 | 12.7 | | |
| 98 | 14.5 | 82.07 | 14.5 | | |
| 99.37 | 16.4 | 83.84 | 16.4 | | |
| 100 | 18.7 | 85.35 | 18.7 | | |
| | | 86.7 | 21.2 | | |
| | | 87.98 | 24.1 | | |
| | | 89.25 | 27.4 | | |
| | | 90.55 | 31.1 | | |
| | | 91.9 | 35.3 | | |
| | | 93.3 | 40.1 | | |
| | | 94.73 | 45.6 | | |
| | | 96.12 | 51.8 | | |
| | | 97.41 | 58.9 | | |
| | | 98.49 | 66.9 | | |
| | | 99.3 | 76 | | |
| | | 99.79 | 86.4 | | |
| | | 100 | 98.1 | | |
| Source data for | | Source data for | | Source data for | |
| FIG. 18 | | FIG. 19 | | FIG. 20 | |
| % Volume Under | Size (μm) | % Volume Under | Size (μm) | % Volume Under | Size (μm) |
| 0 | 0.594 | 0 | 0.523 | 0 | 0.523 |
| 0.38 | 0.675 | 0.07 | 0.594 | 0.07 | 0.594 |
| 1.28 | 0.767 | 0.47 | 0.675 | 0.51 | 0.675 |
| 2.68 | 0.872 | 1.36 | 0.767 | 1.48 | 0.767 |
| 4.35 | 0.991 | 2.68 | 0.872 | 2.91 | 0.872 |
| 6.07 | 1.13 | 4.22 | 0.991 | 4.58 | 0.991 |
| 7.71 | 1.28 | 5.75 | 1.13 | 6.23 | 1.13 |
| 9.31 | 1.45 | 7.18 | 1.28 | 7.75 | 1.28 |
| 11 | 1.65 | 8.56 | 1.45 | 9.18 | 1.45 |
| 12.92 | 1.88 | 10.03 | 1.65 | 10.67 | 1.65 |
| 15.18 | 2.13 | 11.76 | 1.88 | 12.4 | 1.88 |
| 17.84 | 2.42 | 13.87 | 2.13 | 14.47 | 2.13 |
| 20.91 | 2.75 | 16.42 | 2.42 | 16.93 | 2.42 |
| 24.36 | 3.12 | 19.4 | 2.75 | 19.78 | 2.75 |
| 28.18 | 3.55 | 22.77 | 3.12 | 22.98 | 3.12 |
| 32.36 | 4.03 | 26.48 | 3.55 | 26.49 | 3.55 |
| 36.87 | 4.58 | 30.47 | 4.03 | 30.29 | 4.03 |
| 41.63 | 5.21 | 34.69 | 4.58 | 34.36 | 4.58 |
| 46.51 | 5.92 | 39.06 | 5.21 | 38.66 | 5.21 |
| 51.33 | 6.72 | 43.48 | 5.92 | 43.11 | 5.92 |
| 55.93 | 7.64 | 47.84 | 6.72 | 47.6 | 6.72 |
| 60.15 | 8.68 | 32 | 7.64 | 51.99 | 7.64 |
| 63.87 | 9.86 | 55.86 | 8.68 | 56.16 | 8.68 |
| 67.07 | 11.2 | 59.34 | 9.86 | 59.99 | 9.86 |
| 69.76 | 12.7 | 62.43 | 11.2 | 63.42 | 11.2 |
| 72.04 | 14.5 | 65.14 | 12.7 | 66.42 | 12.7 |
| 74.03 | 16.4 | 67.56 | 14.5 | 69.05 | 14.5 |
| 75.83 | 18.7 | 69.77 | 16.4 | 71.39 | 16.4 |
| 77.54 | 21.2 | 71.86 | 18.7 | 73.51 | 18.7 |
| 79.21 | 24.1 | 73.89 | 21.2 | 75.49 | 21.2 |
| 80.87 | 27.4 | 75.88 | 24.1 | 77.38 | 24.1 |
| 82.52 | 31.1 | 77.81 | 27.4 | 79.19 | 27.4 |
| 84.17 | 35.3 | 79.66 | 31.1 | 80.91 | 31.1 |
| 85.81 | 40.1 | 81.4 | 35.3 | 82.54 | 35.3 |
| 87.47 | 45.6 | 83.01 | 40.1 | 84.09 | 40.1 |
| 89.16 | 51.8 | 84.51 | 45.6 | 85.59 | 45.6 |
| 90.87 | 58.9 | 85.95 | 51.8 | 87.11 | 51.8 |
| 92.59 | 66.9 | 87.41 | 58.9 | 88.7 | 58.9 |
| 94.31 | 76 | 88.95 | 66.9 | 90.41 | 66.9 |
| 95.94 | 86.4 | 90.64 | 76 | 92.25 | 76 |
| 97.42 | 98.1 | 92.46 | 86.4 | 94.15 | 86.4 |
| 95.63 | 111 | 94.37 | 98.1 | 96.01 | 98.1 |
| 99.48 | 127 | 96.22 | 111 | 97.66 | 111 |
| 99.93 | 144 | 97.83 | 127 | 98.92 | 127 |
| 100 | 163 | 99.04 | 144 | 99.7 | 144 |
| | | 99.76 | 163 | 100 | 163 |
| | | 100 | 186 | | |

1-67. (canceled)

68. A method comprising microfluidizing a paste of oily seeds at a pressure of at least 5,000 PSI.

69. The method of claim 68, wherein said oily seeds are selected from the group consisting of white sesame, red sesame, black sesame, nigella, peanuts, pistachios, almonds, Brazil nuts, macadamia nuts, hazelnuts, pecans, cashews, olives (with pits removed), sunflower seeds, corn kernels, wheat kernels, and soybeans.

70. The method of claim 68, wherein said paste of oily seeds is crude tahini.

71. The method of claim 70, wherein said crude tahini comprises whole crude tahini.

72. The method of claim 68, further comprising removing oil from the microfluidized paste obtained.

73. The method of claim 72, wherein said removing oil comprises centrifuging said microfluidized paste; or said removing oil removes at least 10% of said oil.

74. A method comprising:
(a) mixing a paste of oily seeds and water to produce an emulsion; and
(b) microfluidizing said paste prior to said mixing, and/or said emulsion after said mixing, at a pressure of at least 5,000 PSI.

75. The method of claim 74, wherein said microfluidizing comprises microfluidizing said paste prior to said mixing.

76. The method of claim 74, further comprising dissolving an emulsifier in said water prior to said mixing.

77. The method of claim 76, wherein said emulsifier is selected from the group consisting of a lecithin, monoglyceride, diglyceride, polysorbate, and saponin; or said emulsifier is rice bran extract (RBE), and said RBE is dissolved in said water in an amount of <12% of the weight of said paste.

78. The method of claim 77, comprising microfluidizing said RBE in said water; and/or heating said RBE in said water.

79. The method of claim 74, further comprising:
(c) drying the product thus obtained to produce a powderized oily seed composition.

80. The method of claim 79, wherein said drying comprises spray drying.

81. The method of claim 74, wherein said oily seeds are selected from the group consisting of white sesame, red sesame, black sesame, nigella, peanuts, pistachios, almonds, Brazil nuts, macadamia nuts, hazelnuts, pecans, cashews, olives (with pits removed), sunflower seeds, corn kernels, wheat kernels, and soybeans.

82. The method of claim 74, wherein said oily seeds comprise sesame seeds, and said paste comprise crude tahini or whole crude tahini.

83. The method of claim 82, comprising:
(a) mixing crude tahini or whole crude tahini and water to produce an emulsion; and
(b) microfluidizing said crude tahini or whole crude tahini prior to said mixing and/or said emulsion after said mixing, at a pressure of at least 5,000 PSI.

84. The method of claim 83, further comprising dissolving RBE in said water prior to said mixing, wherein said RBE is dissolved in said water in an amount of <12% of the weight of said crude tahini or whole crude tahini.

85. The method of claim 84, comprising microfluidizing said RBE in said water; and/or heating said RBE in said water.

86. The method of claim 83, further comprising:
(c) drying said emulsion to provide a powderized tahini, wherein said drying comprises spray drying.

87. A method comprising:
(a) mixing crude tahini and water to produce an emulsion; and
(b) spray drying said emulsion to produce powderized tahini.

88. The method of claim 87, further comprising dissolving rice bran extract (RBE) in an amount of <12% of the weight of said crude tahini in said water.

89. A crude tahini composition characterized by a viscosity cP SC4-21 at 5 RPM of less than 2100 and/or a viscosity cP SC4-21 at 11 RPM of less than 1700.

90. The crude tahini composition of claim 89, characterized by a Particle Size Distribution (PSD) of 90% of less than 55 μm as measured by laser diffraction using a Malvern—Mastersizer 3000 Wet dispersion with Hydro EV cell with Isopar G as dispersant.

91. A whole grain crude tahini composition characterized by a viscosity cP SC4-21 at 5 RPM of less than 1725 and/or a viscosity cP SC4-21 at 11 RPM of less than 1410.

92. The whole grain crude tahini composition of claim 91, characterized by a Particle Size Distribution (PSD) of 90% of less than 72 μm as measured by laser diffraction using a Malvern—Mastersizer 3000 Wet dispersion with Hydro EV cell with ISOPAR G as dispersant.

93. A whole grain crude tahini composition comprising at least 13% crude fiber in a proximate analysis and characterized by a viscosity cP SC4-21 at 5 RPM of less than 4900 and/or a viscosity cP SC4-21 at 11 RPM of less than 4000.

94. The whole grain crude tahini composition of claim 93, characterized by a Particle Size Distribution (PSD) of 90% of less than 115 μm as measured by laser diffraction using a Malvern—Mastersizer 3000 Wet dispersion with Hydro EV cell with ISOPAR G as dispersant.

95. A crude tahini composition, wherein upon mixing with water at a weight ratio of 5:3 (crude tahini:water, respectively), an emulsion having a first viscosity and a second viscosity is obtained, wherein said first viscosity is about identical to the viscosity of said crude tahini prior to said mixing, and it is observed immediately upon formation of said emulsion; and said second viscosity is higher than said first viscosity and it is observed not less than 5-6 seconds after formation of said emulsion.
